(19) United States
(12) Patent Application Publication
(10) Pub. No.: US 2025/0252949 A1
(43) Pub. Date: Aug. 7, 2025

(54) METHOD AND SYSTEM FOR PROCESSING A VOICE INPUT IN VOICE ASSISTANT DEVICES

(71) Applicant: SAMSUNG ELECTRONICS CO., LTD, Suwon-si (KR)

(72) Inventors: Debojyoti SAHA, Bengaluru (IN); Krishna SINGH, Bengaluru (IN); Vinay Vasanth PATAGE, Bengaluru (IN); Javaid NABI, Bengaluru (IN)

(73) Assignee: SAMSUNG ELECTRONICS CO., LTD., Suwon-si (KR)

(21) Appl. No.: 19/073,170

(22) Filed: Mar. 7, 2025

Related U.S. Application Data
(63) Continuation of application No. PCT/KR2025/001576, filed on Jan. 31, 2025.

(30) Foreign Application Priority Data
Feb. 2, 2024 (IN) 202441006991
Oct. 24, 2024 (IN) 202441006991

(51) Int. Cl. G10L 15/01; G10L 15/08; G10L 15/183; G10L 15/22

(52) U.S. Cl. CPC G10L 15/01; G10L 15/183; G10L 15/22; G10L 2015/088; G10L 2015/223; G10L 2015/228

(57) ABSTRACT

The disclosure relates to a method and apparatus for processing a voice input. The method includes identifying a first candidate text output from a first list of candidate text outputs, the first list of candidate text outputs being generated based on a voice input being received from a user. The method includes validating a feasibility of executing the first candidate text output based on an analysis of a first contextual data related to the first candidate text output, user-specific data, historical data related to previous validations of the voice assistant device, and one of an execution result or a no-action result corresponding to the first candidate text output. The method includes, based on the feasibility of executing the first candidate text output being validated as not feasible for execution, identifying failure information associated with the first candidate text output.

### CROSS-REFERENCE TO RELATED APPLICATION(S)

This application is a bypass continuation of an International application No. PCT/KR2025/001576, filed on Jan. 31, 2025, which is based on and claims priority to Indian Provisional Patent Application No. 202441006991, filed on Feb. 2, 2024, in the Indian Intellectual Property Office, and Indian Complete patent application No. 202441006991, filed on Oct. 24, 2024, in the Indian Intellectual Property Office, the disclosures of which are incorporated by reference herein in their entireties.

### BACKGROUND

### 1. Field

The disclosure relates to digital assistant devices, more particularly to a method and system for processing voice input in voice assistant devices.

### 2. Description of Related Art

A voice assistant device also known as a digital assistant device, voice digital assistant, or voice-controlled digital assistant, is a digital tool that employs voice recognition, speech synthesis, and Natural Language Processing (NLP) to deliver services via a specific application. The voice assistant devices offer connected functionalities that enable users to interact verbally with them to access information, either locally or remotely through a cloud service. This information could be internet-based, or it could come from a user's own device. Furthermore, the voice assistant devices can control and interact with other connected devices such as smart devices. The voice assistant devices are activated by one or more specific spoken words or phrases, followed by a spoken command that the user wants the voice assistant device to execute.

A voice assistant device operates through a streamlined process that begins with the user's voice input, captured by a microphone. This audio input is processed by an Automatic Speech Recognition (ASR) system, which includes an audio signal encoder to convert the sound into a processable format and a streaming decoder to transcribe the audio into text. The transcribed text is then analyzed by a Natural Language Understanding (NLU) system. The NLU system uses Natural Language Processing (NLP) to understand the meaning of the user's request. It extracts the intent, or the action to be performed, and the slots, or the specific pieces of information needed to carry out the intent. For instance, in the command “Book a flight from Denver to New Jersey”, the intent is “book flight”, and the slots are “origin” (Denver) and “destination” (New Jersey). These components of the voice assistant work together to enable the voice assistant to accurately understand and execute the user's voice input.

In voice assistant devices, several factors determine the success or failure of a user request, beyond the accuracy of the ASR and NLU systems. For instance, ASR systems and NLP may try to make corrections in some basic scenarios.

As example scenario 1:
user's voice input: “What is inheritance tax?”
voice input processed by ASR: “What is inheritance tags?”
NLP correction: No correction
NLU identified capsule: Smart Things
Executed Action: No action executed.

As shown above, the NLP system does not correct an error introduced by the ASR, because the generated error by the ASR is grammatically correct, and it can be mapped to one of the valid/supported capsule (a capsule according to the disclosure may be a domain related to the context of the voice input). However, upon identification of an action by the NLU system, the NLU system fails to find a relevant action under the mapped capsule. Consequently, the action execution fails to provide relevant information because it cannot find any tags named “inheritance”. This example highlights how word similarity can lead to slot failure, where the system fails to recognize and process the correct query about inheritance tax, demonstrating the importance of accurate slot recognition in voice assistant systems.

Another example scenario 2:
user's voice input: “Turn on ice maker”
voice input processed by ASR: “Turn on rice maker”
NLP correction: No correction
NLU identified capsule: Smart Things
Executed Action: No action executed.

The NLP system does not correct the recognized voice input since “rice maker” is a valid Named Entity Recognition (NER). When the voice assistant provides an output that is not what the user wanted in response to the user input (e.g., “I am unable to process your request”, or the voice assistant generates the wrong output, etc.), it causes friction in the user experience. There are various reasons for the occurrence of an error during a user's interaction with the voice assistant device. For example, there could be errors relating to ASR, NLU, and/or there could also be errors caused by the user's environment, such as background noise, distance of the user from the microphone i.e., when the user is too far from the microphone, or poor voice quality of the user i.e., when the user speaks softly. In such cases, the user's speech or voice input may not be captured properly, which in turn leads to incorrect processing and recognition of the voice input. Although there are existing related art solutions for improving standalone ASR and NLP, these solutions fail to consider the overall voice assistant response status before responding to the user. In some other scenarios, as the word error rate of ASR increases with multiple potential error positions, the potential error in NLP action determination also increases, leading to more possible outcomes. This makes the overall system highly unpredictable and may result in undesirable outcomes for the user's voice input.

There is a need for a correction mechanism that considers both the ASR and NLP subsystem results, along with several other conditions and/or information to make dynamic error corrections and produce desirable outcome for the user's voice input.

### SUMMARY

According to an aspect of the disclosure, there is provided a method of processing voice input in a voice assistant device, the method including: identifying a first candidate text output from a first list of candidate text outputs, the first list of candidate text outputs being generated based on a voice input being received from a user; validating a feasibility of executing the first candidate text output based on an analysis of a first contextual data related to the first candidate text output, user-specific data, historical data related to previous validations of the voice assistant device, and one of an execution result or a no-action result corresponding to the first candidate text output; based on the feasibility of executing the first candidate text output being validated as not feasible for execution, identifying failure information associated with the first candidate text output; generating a second list of candidate text outputs and corresponding text embeddings based on the failure information, the first list of candidate text outputs, and second contextual data related to the user and the voice assistant device; identifying a second candidate text output for the voice input from the second list of candidate text outputs based on a correlation of the corresponding text embeddings of each candidate text output of the second list of candidate text outputs with an audio embedding of the voice input; and based on the voice input being received from the user, executing an action corresponding to the second candidate text output.

The first candidate text output may be identified based on the audio embedding of the voice input, text recognized from the voice input, and the first list of candidate text outputs generated for the voice input based on the audio embedding of the voice input and the text recognized from the voice input.

The validating the feasibility of executing may include: generating, through a first trained artificial intelligence (AI) model, the first contextual data related to the first candidate text output based on an analysis of the first candidate text output; assigning, through the first trained AI model, a validation confidence score to the first candidate text output based on the analysis of the generated first contextual data, the user-specific data, and the historical data related to previous validations of the voice assistant device; comparing, through the first trained AI model, the validation confidence score of the first candidate text output with a dynamic threshold value, wherein the dynamic threshold value may be generated for the first candidate text output based on word level confidence score of each word of the first candidate text output and a contextual relationship between each word of the first candidate text output; and validating, through the first trained AI model, the feasibility of executing the first candidate text output as feasible for execution or not feasible for execution.

The feasibility of executing the first candidate text output may be validated as feasible for execution based on the validation confidence score of the first candidate text output being greater than or equal to a dynamic threshold value; and wherein the feasibility of executing the first candidate text output may be validated as not feasible for execution based on the validation confidence score of the first candidate text output being less than the dynamic threshold value.

The first contextual data may include at least one of an intent of the first candidate text output, a slot of the first candidate text output, a word level confidence score of each word of the first candidate text output, contextual relationship between each word of the first candidate text output and a context associated with the voice input, and previous voice inputs of the user to the voice assistant device.

The second contextual data may include the user-specific data, data related to Internet of things (IoT) devices associated with the voice assistant device of the user, and a knowledge graph derived from centralized information related to previous validations performed by a plurality of voice assistant devices for a plurality of voice inputs, corresponding to executed actions and phonetically similar keywords.

The failure information may be identified by a trained AI classification model, and wherein the failure information may include at least one of a type of a failure associated with the first candidate text output, position of words responsible for the failure of the first candidate text output and a word level confidence score of each word responsible for the failure in the first candidate text output.

The method may include categorizing, by the voice assistant device, the failure information into a type of a failure, wherein the type of the failure may include at least one of a slot failure, an intent failure, a goal jump failure, or a planning failure.

The second list of candidate text outputs and the corresponding text embeddings may be generated by a second trained AI model, and wherein the second list of candidate text outputs may include a plurality of candidate text outputs phonetically similar to text recognized from the voice input.

Identifying the second candidate text output from the second list of candidate text outputs by a third trained AI model may include: identifying self-attention data based on text embeddings of each of a plurality of candidate text outputs in the second list of candidate text outputs; identifying cross-attention data based on the text embeddings of each of the plurality of candidate text outputs in the second list of candidate text outputs and the audio embedding of the voice input; assigning an attention score for each of the plurality of candidate text outputs in the second list of candidate text outputs based on the identified self-attention data and the identified cross-attention data; and identifying the second candidate text output for the voice input from the plurality of candidate text outputs in the second list of candidate text outputs based on the attention score.

The second candidate text output may be executed based on the feasibility of execution of the second candidate text output being validated as feasible for execution.

The method may include identifying subsequent candidate text outputs consecutively based on the feasibility of executing the second candidate text output being validated as not feasible for execution, until one of: the feasibility of executing one of the subsequent candidate text outputs is identified as feasible for execution; or a number of validations of the subsequent candidate text outputs exceeds a predefined threshold number of validations.

According to an aspect of the disclosure, there is provided a voice assistant device for processing voice input including: at least one processor; and memory storing instructions; and at least one processor communicatively coupled to the memory and configured to execute the instructions, wherein the instructions, when executed by the at least one processor, cause the voice assistant device to: identify a first candidate text output from the first list of candidate text outputs, the first list of candidate text inputs being generated based on a voice input being received from a user; validate a feasibility of executing the first candidate text output based on an analysis of a first contextual data related to the first candidate text output, user-specific data, historical data related to previous validations of the voice assistant device and one of an execution result or a no-action result corresponding to the first candidate text output; based on the feasibility of executing the first candidate text output being validated as not feasible for execution, identify failure information associated with the first candidate text output; generate a second list of candidate text outputs and corresponding text embeddings based on the failure information, the first list of candidate text outputs and second contextual data related to the user and the voice assistant device; identify a second candidate text output for the voice input from the second list of candidate text outputs based on correlation of the corresponding text embeddings of each candidate text output of the second list of candidate text outputs with an audio embedding of the voice input; and based on the voice input being received from the user, execute an action corresponding to the second candidate text output.

The processor-executable instructions, when executed by the at least one processor, may cause the voice assistant device to identify the first candidate text output based on the audio embedding of the voice input, text recognized from the voice input and the first list of candidate text outputs generated for the voice input based on the audio embedding of the voice input and the text recognized from the voice input.

According to an aspect of the disclosure, there is provided a non-transitory computer readable recording medium including a program that executes a controlling method of a voice assistant device, the controlling method including: identifying a first candidate text output from the first list of candidate text outputs, the first list of candidate text outputs being generated based on a voice input being received from a user; validating a feasibility of executing the first candidate text output based on analysis of a first contextual data related to the first candidate text output, user-specific data, historical data related to previous validations of the voice assistant device and one of an execution result or a no-action result corresponding to the first candidate text output; based on the feasibility of executing the first candidate text output being validated as not feasible for execution, identifying failure information associated with the first candidate text output; generating a second list of candidate text outputs and corresponding text embeddings based on the failure information, the first list of candidate text outputs and second contextual data related to the user and the voice assistant device; identifying a second candidate text output for the voice input from the second list of candidate text outputs based on correlation of the corresponding text embeddings of each candidate text output of the second list of candidate text outputs with an audio embedding of the voice input; and based on the voice input being received from the user, executing an action corresponding to the second candidate text output.

The first candidate text output may be identified based on the audio embedding of the voice input, text recognized from the voice input, and the first list of candidate text outputs generated for the voice input based on the audio embedding of the voice input and the text recognized from the voice input.

Validating the feasibility of executing may include: generating, through a first trained artificial intelligence (AI) model, the first contextual data related to the first candidate text output based on an analysis of the first candidate text output; assigning, through the first trained AI model, a validation confidence score to the first candidate text output based on the analysis of the generated first contextual data, the user-specific data, and the historical data related to previous validations of the voice assistant device; comparing, through the first trained AI model, the validation confidence score of the first candidate text output with a dynamic threshold value, wherein the dynamic threshold value may be generated for the first candidate text output based on word level confidence score of each word of the first candidate text output and a contextual relationship between each word of the first candidate text output; and validating, through the first trained AI model, the feasibility of executing the first candidate text output as feasible for execution or not feasible for execution.

The feasibility of executing the first candidate text output may be validated as feasible for execution based on the validation confidence score of the first candidate text output being greater than or equal to a dynamic threshold value; and wherein the feasibility of executing the first candidate text output may be validated as not feasible for execution based on the validation confidence score of the first candidate text output being less than the dynamic threshold value.

The first contextual data may include at least one of an intent of the first candidate text output, a slot of the first candidate text output, a word level confidence score of each word of the first candidate text output, contextual relationship between each word of the first candidate text output and a context associated with the voice input, and previous voice inputs of the user to the voice assistant device.

The second contextual data may include the user-specific data, data related to Internet of things (IoT) devices associated with the voice assistant device of the user, and a knowledge graph derived from centralized information related to previous validations performed by a plurality of voice assistant devices for a plurality of voice inputs, corresponding to executed actions and phonetically similar keywords.

### BRIEF DESCRIPTION OF THE DRAWINGS

The accompanying drawings, which are incorporated in and constitute a part of this disclosure, illustrate example embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1A shows an example architecture for processing a voice input, in accordance with some embodiments of the disclosure;

FIG. 1B shows an example voice assistant device for processing voice input, in accordance with some embodiments of the disclosure;

FIG. 2A shows a detailed block diagram of the voice assistant device, in accordance with some embodiments of the disclosure;

FIG. 2B shows a detailed block diagram of the one or more modules of the voice assistant device, in accordance with some embodiments of the disclosure;

FIG. 2C shows a detailed block diagram of the hypothesis generation module of the voice assistant device, in accordance with some embodiments of the disclosure;

FIG. 2D shows a detailed block diagram of the reinforced decoder of the voice assistant device, in accordance with some embodiments of the disclosure;

FIG. 3 shows an example sequence diagram illustrating a method of processing voice input in a voice assistant device, in accordance with some embodiments of the disclosure;

FIG. 4 shows an example flowchart illustrating a method of processing voice input in a voice assistant device, in accordance with some embodiments of the disclosure;

FIG. 5A and FIG. 5B show flowcharts illustrating example scenarios of processing voice inputs in a voice assistant device, according to the embodiments of the disclosure;

FIG. 6 is a block diagram of an example computer system for implementing embodiments consistent with the disclosure.

It should be appreciated by those skilled in the art that any block diagrams herein represent conceptual views of illustrative systems embodying the principles of the present disclosure. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the disclosure, the word “example” is used herein to mean “serving as an example, instance, or illustration.” Any embodiment or implementation of the present subject matter described herein is an “example” is not necessarily to be construed as preferred or advantageous over other embodiments.

While the disclosure includes various modifications and alternative forms, embodiments thereof have been shown by way of example in the drawings and will be described in detail below. It should be understood, however, that it is not intended to limit the disclosure to the particular forms disclosed, but on the contrary, the disclosure is to cover all modifications, equivalents, and alternative falling within the scope of the disclosure.

The terms “comprises”, “comprising”, “includes”, “including”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises” or “includes” does not, without more constraints, preclude the existence of other elements or additional elements in the device or system or apparatus.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

In the following detailed description of the embodiments of the disclosure, reference is made to the accompanying drawings that form a part hereof, and in which are shown by way of illustration of embodiments in which the disclosure may be practiced. These embodiments are described in sufficient detail to enable those skilled in the art to practice the disclosure, and it is to be understood that other embodiments may be utilized and that changes may be made without departing from the scope of the disclosure. The following description is, therefore, not to be taken in a limiting sense.

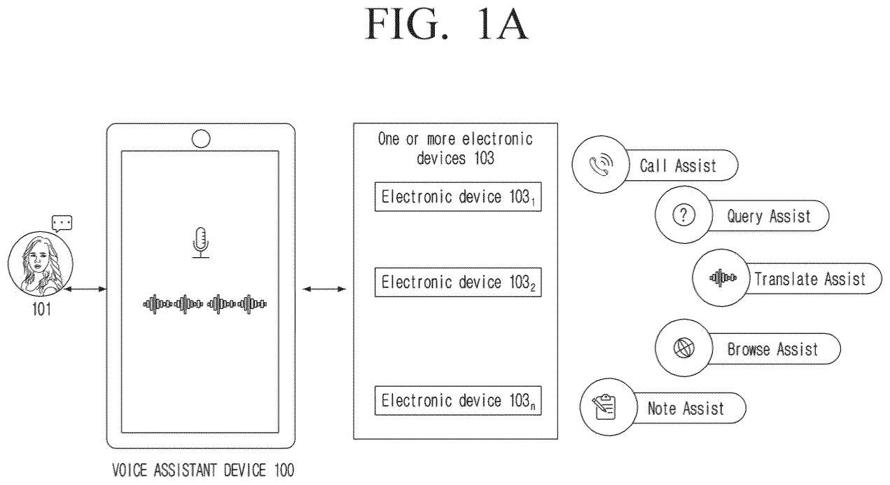

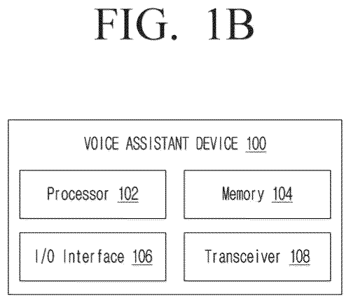

Automated Speech Recognition (ASR) systems may perform corrections for basic scenarios. There has been ample number of research articles available to enhance the ASR accuracy. For e.g., contextual spelling correction, using operation predictions, a N-best hypothesis re-ranking. Additionally, there are also research available to enhance the NLP system for ASR failures. However, the current ASR system does not capture final action execution in a voice assistant system. Consequently, the ASR may fail even though when ASR and Natural Language Programming (NLP) system independently recognizes the results correctly. FIG. 1A shows an existing solution for ASR correction and FIG. 1B shows an existing solution for Natural Language Understanding (NLU) correction in the ASR system. If the error is generated by ASR and if it is not corrected by the NLP system, this may lead to over-all system response to be erroneous, and simultaneously create a bad experience to the user. Similarly, the voice assistant does not perform auto-correction of over-all system response without the intervention of the user.

In the voice assistant there are multiple other factors which determine the overall success or failure of a user request other than the accuracy of ASR and NLU systems. Such external factors like the noisy user environment, available set of devices, their names, search result output, action performance status etc., are not considered when over-all voice assistant system response is to be enhanced by means of error correction. Related art does not consider the overall voice assistant response status before responding to the user.

An example scenario 1 (i.e., when the error is generated due to word similarity or slot failure.) An issue with the existing solution for the scenario 1 is that sometimes, there are no correction possible at ASR or NLP as stand-alone system, but over-all system can still fail to produce a correct output. Another example scenario 2 (i.e., due to Named Entity Recognition (NER) failures to matching names or intent failure or capsule jump.) An issue with the existing solution for the scenario 1 is sometimes, due to noisy environment, ASR can predict wrong, however, NLP system may fail to identify the error in ASR. Thus, resulting in overall system response failure. Another example scenario 3 (i.e., side effects of the improved NLP). An issue with an existing solution for the scenario 3 is, without the phonetic info of ASR, NLU can make a correction which does not match the original data. Another example scenario 4 (i.e., device dependency or slot failure). An issue with an existing solution for the scenario 4 is, only after the action execution phase, it is evident that the device is associated with user or not. Hence, correction at NLP isn't possible. Another example scenario 5 (i.e., user specific info (privacy) failures or goal jump). An issue with an existing solution for the scenario 5 is, user specific info is private to user and may not be available for boosting ASR and/or NLU accuracy. Hence, correction at NLP is not possible.

Another example scenario 6 (i.e., multiple stand-alone corrections at multiple parts of the user input or multiple possibilities). As observed in the scenario 6, with the increase in the word error rate of ASR with multiple possible positions of potential errors, the auto prediction of NLP also increases with more possible outcomes. This makes the overall system highly unpredictable or it may produce an outcome which is undesirable for the user's input. Also, a correction module takes both the ASR and NLP sub-system results into consideration along with an Execution Validator outcome to make dynamic error correction. An issue with an existing solution for the scenario 5 is, without the phonetic info of ASR, NLU can make a correction which does not match the original audio.

The disclosure relates to method for processing a speech input. The method comprising converting by an automatic speech recognition module, a speech input into at least a text and at least an audio embedding, processing by a natural language understanding module, the command embodied in the text, detecting occurrence of a failure in the processing by the natural language understanding module, determining one or more type of a failure & a position of the failure in the conversion of the speech input, subsequent to the occurrence of failure; correlating using a pre-trained artificial intelligence (AI) model, the type and/or position of the failure with one or more of a user knowledge graph, a user personal data and a user IoT data, generating a candidate list of texts as a result of correlation, comparing the candidate list with the audio embedding to identify target text that matches with the speech input and decoding the target text from the audio embedding to ensure phonetic correctness, and passing the target text onto the natural language understanding module for processing and result generation for the speech input.

Initially, a user may provide utterance for his requirement. Due to external influence like noisy surroundings or presence of rare words or ITN issues, ASR detects the final 1-best hypothesis with possible error. This error doesn't get resolved by the NLP system, resulting in the wrong or no-action execution result. Before responding to the user, our Execution Validator unit will analyze the response generated based on user input, detect the intent, slots, user metadata, context of the command & previous result cache. This analyzed response is assigned with a confidence level for accuracy of user action execution, for a given user input. If confidence is found to be high, over a given threshold, then the user utterance is executed as the action being detected in the previous steps. However, on finding low confidence level in execution, our Failure identifier module is triggered to identify the word(s) and/or part(s) of sentence responsible for such low confidence in the action execution. The identified word(s) with position and Failure type are combined with confidence score for those word(s) are passed on to our Intelligent Hypothesis Generator. The Intelligent Hypothesis Generator also has got the input of n-best hypothesis from the first loop of operation for the user utterance along with each of hypothesis' word level confidence score. Thus, the Intelligent Hypothesis Generator will take into account the above data, to retrieve the additional information like valid set of utterances and voice assistant specific user data via voice assistant Data Retriever using RAG approach. All of this retrieved data are used with the language model to come up with Alternative list of m-best ASR Hypothesis. On receiving the alternative list of m-best ASR Hypothesis, the Reinforced ASR decoder unit will decode the original user input Audio embedding & Alternative list of m-best Hypothesis to generate the enhanced 1-Best Hypothesis. Thus, the enhanced Hypothesis is re-processed through NLU to provide the enhanced and accurate experience to the user.

The framework comprises of distinct and definitive steps that collaboratively contribute to accurate and contextually meaningful speech processing. The steps may include converting speech into both textual and audio representation, identifying and categorizing the failure in natural language understanding, and dynamically correcting the errors through phonetic matching and audio decoding. Accordingly, the new framework due to its innovative integration of these elements, addresses the limitation of existing voice assistance based systems and establishes a more precise and context-aware approach to speech input processing.

The disclosure provides a holistic approach to address the challenges associated with processing speech input in real-world scenarios. Key aspects of the holistic approach include failure identification and correlation, dynamic error correction and phonetic matching and decoding.

In failure identification and correlation—the disclosure introduces a systematic approach to detect (Validator Module) and categorize failures (Failure Identifier) in Natural Language Understanding, going beyond the traditional error handling approaches. This ensures a more nuanced understanding of the errors.

In dynamic error correction—by correlating the identified failures with the user specific data and using a pre-trained AI model, the Intelligent Hypothesis Generator generates a candidate list contextually suitable for user speech input and dynamically produces suggestions for error correction based on phonetic similarity. This dynamic correction system significantly improves accuracy of the overall system.

In phonetic matching and decoding—The use of phonetic matching to identify phonetically matching a target text and subsequent decoding in real-time by reinforced ASR decoder from the audio embedding ensures that the correlations align with user's intended pronunciation, adding a dimension to error correction in speech processing.

The disclosure's framework finds its application in various domains, including but not limited to:

Voice Assistance: Enhancing accuracy and comprehension of voice assistance in understanding and executing user commands.

Customer Support: Improving the effectiveness of automated customer support systems by accurately interpreting the user speech queries & providing the precise responses

Transcription Services: Enabling more accurate and context-aware transcription of spoken content.

Language Learning: Facilitating advanced language learning applications, as a by-product of dynamic error correlation & phonetic matching algorithm to ensure phonetically accurate pronunciation.

IoT Integration: Enhancing user interaction with IT devices by accurate interpretation of spoken commands.

Prerequisite: voice assistance failure to perform user requested Action. User has provided an utterance to a voice assistance system. The voice assistance's ASR subsystem has resulted in sub-par recognition, which with cascaded effect has produced a failure to perform Action by the voice assistance system. (Proposed solution).

At step 1, validate the action execution by voice assistance system: The voice assistant validator may perform validation of action executed by the voice assistance system. If validation terms to be success, then provide result to the user. Otherwise, identify the possible category of failure of the action to be executed. According to step-1, validation to be done only once per user utterance to make sure the overall system responds in real-time and to avoid infinite loop of execution.

At step 2, Intelligent alternative hypothesis generation: Based on the received report of validation and category of result, intelligently identify the possible location of the error in ASR transcription, causing the action execution to fail. Obtain a set of highly related voice assistant's valid response set based on the knowledge graph and user specific data, to generate a set of alternate m-best hypothesis corresponding to the location of the error identified in ASR transcript.

At step 3, reinforced ASR decoder: A decoder of ASR, which is capable to generate alternate one-best hypothesis based on the phonetic information available in original user audio embedding, which is grounded by the alternate m-best hypothesis received from the previous phase. Thus, proposed solution effectively resolves the cascaded effect of error output produced by downstream modules (such as NLP) in a voice assistance.

A user may provide his/her utterance, the audio encoder may encode the signal and provide the audio embedded to streaming decoder. The ‘streaming decoder’ performs embedding decoding in the first pass of user utterance speech recognition by ASR module. ‘Reinforced decoder’ only comes into picture in the feedback loop, if first pass ASR outcome is identified to be failure by ‘Execution Validator.

The decoded signal is provided to the NLP and action planner. The NLP may take necessary action on the signal and pass the signal to the execution validator. The execution validator may check whether the signal is valid or invalid. If the signal is valid, then the execution validator may transmit the signal directly to the voice assistant and there may be no hypothesis updated. If the signal is invalid, then the execution validator may send invalid response to the failure identifier. In the first iteration, the failure identifier may identify the failure results and provided to the intelligent hypothesis generator. Similarly, n-best hypothesis is also provided to the intelligent hypothesis generator. The intelligent hypothesis generator may retrieve valid set and transmit to the voice assistant retriever. The voice assistant retriever may generate voice assistant knowledge graph and the user specific voice assistant valid set may be transmitted to intelligent hypothesis generator along with the language model. The intelligent hypothesis generator may generate m-best alternate hypothesis and provided to the reinforced decoder. The encoded audio signal embedded is provided to the reinforced decoder. The reinforced decoder may generate best alternate hypothesis. Accordingly, the response of the NLP is enhanced.

A user provides an input, for example, user speech input “turn on ICE maker”, the user speech input is provided to ASR decoder. The ASR decoder may estimate n-best alternate, for example, turn on rice maker, turn on rice cooker, turn on ice maker, turn on price maker, and/or turn on mice tracker. Additionally, the ASR decoder provide an output (i.e., first pass failure) as “turn on rice maker”. The output is provided to the NLU action. The NLU action may not find “rice maker” in the device list and same signal is provided to the validator and failure identifier. The validator and failure identifier may provide the output as failed and a slot failure to the intelligent hypothesis generator. The intelligent hypothesis generator with slot failure information and ASR n-best alternates provide alternate m-best hypothesis and text embedded. The alternate m-best hypothesis and text embedded is provided to the reinforced ASR decoder. Also, the Reinforced ASR decoder receives the audio embedding of the actual user utterance when the user has provided. Subsequently, generate the second pass success (i.e., turn on ICE maker). The second pass may be provided to NLU action. The NLU may turn on ICE maker on family hub, and actions are taken by the voice assistant based on the conversation actions.

An execution validator is one part of the solution responsible to identify the utterance validity & it's accuracy, and thus trigger response enhancement down-stream tasks. The execution validator may assign a confidence score to the perceived response for a given user utterance detected by the ASR sub-system. If the confidence score to be found above the level of dynamically determined threshold then the perceived response will be considered ‘Success/Correct’ and be delivered to voice assistant device for execution. However, if the perceived response confidence is found to be below the dynamically determined threshold, then it will be marked ‘Fail’ and be considered as a candidate for response improvement. Execution Validator also has a ‘Result cache’ to store the response and it's category of validation result. ‘Result cache’ makes sure that the operation of ASR response improvement does not end up to be an infinite loop in action.

A failure validator module implementation details, in accordance with some embodiments of the disclosure. Result cache holds the result's metadata and checks if the utterance has been corrected once. If the utterance has already been corrected, result cache will take this utterance response so that the system does not go in a loop of correction. This will help in preventing latency increase. This acts as a trigger for classification model. AI model like classification model can be trained for giving the confidence score of correctness for a given conversation. It is trained in a semi-supervised way, using augmented data and consistency loss. It takes a conversation as input, encodes the tokens to embedding and outputs a confidence score. The expected outcome is a confidence score in the range of 0-1. The dynamic threshold detector will dynamically select a threshold to classify the conversation as fail/success. It will classify the result based on dynamically determined threshold for the user utterance, based on received word level confidence level and contextual relation of the words.

Failure Identifier is a multi-class classification model, responsible for classifying the error type that has caused the low confidence level voice assistant response, performing the classification based on the received metadata from NLU action such as user utterance intent, slots, goal, and action plan, identifying the position of the error in ASR hypothesis, aided by the classified failure type and assign probability of error for each such word or group of words in the ASR hypothesis of the user utterance, and failure identifier module sends the failure type, the positions of the word(s) responsible for failure and corresponding probability of error values to the down-stream tasks.

In training, a multi-class classification model is trained with voice assistant specific data to classify the user utterance, NLP outcome & action execution details to classify failure type in user utterance-response into one of the below classes.

Slot Failure—To identify the errors in slot identification due to similar sounding phonemes.

Intent/Domain Failures—To identify whether the utterance has resulted into out-of-domain result, caused due to mispronunciation or misinterpretation.

Goal Jump Failures—To identify whether the follow up or contextual commands are resulted with unexpected goal for action execution, may be caused by lack of domain specific words in the ASR hypothesis.

Planning Failures—To identify the grammatical mistakes that has caused the user action planning to fail to execute in the response.

Intelligent hypothesis generator is an AI module, which incorporates the outputs of failure identifier, ASR n-best hypothesis, supported voice assistant's inputs and user specific voice assistant's data to generate the alternate list of hypothesis. The Intelligent Hypothesis Generator (IHG) is responsible for generating alternate m-best hypothesis. This component ensures that the correction suggested do not go out of scope of voice assistant capabilities.

A voice assistant data retriever module is responsible to get contextually & semantically closest matching valid data for the user input. The voice assistant data retriever module may be necessary to ground the intelligent hypothesis generator's scope, so that the generator does not hallucinate, and produce the precise info for reinforced ASR decoder.

Voice assistant data retriever is consisting of the following sub-systems—

### Voice Assistant Knowledge Graph:

It is a knowledge graph created out of all the valid voice assistant utterances and responses.

This graph is obtained from generic user data collected from millions of devices supporting voice assistant operations.

Entries are added to the knowledge graph only after the query and responses are found to be valid for voice assistant operations.

### User Personal Data:

User's personal data such as contact names, app names, region, locale, profile data, etc., is used to correctly identify the phonetic errors

Such user data will be of great help to make the corrective suggestion to the reinforced ASR decoder for informed correction.

### Smart Devices/IoT User Data:

Similar to user's personal data, IoT data of the user is also useful in accurately identifying errors in ASR hypothesis.

The failure type and the word identified by the failure identifier module in the utterance is passed to voice assistant data retriever to get contextually and semantically closest matching valid data for the user utterance. An example to understand the module (Utterance: Turn on ICE maker)

TABLE 1

| ASR | Failure Identifier | KG Query | KG output |
|---|---|---|---|
| Turn on rice maker | Type: Slot Failure | KG will be queried | 1. Turn on Coffee- |
| | Position/Word: rice | with Turn on | Maker |
| | | capability utterances | 2. Turn on Rice- |
| | | for supported voice | maker |
| | | assistant utterances | 3. Turn on Wi-Fi |
| | | | 4. Turn on TV |
| | | | 5. Turn on kitchen |
| | | | light |
| | | | 6. Turn on alarm |
| | | | 7. Turn on camera |
| | | | 8. Turn on Ice- |
| | | | Maker |

After we get the output from KG, it gets filtered with the personalized smart devices data available in the cloud, because the identified command “Turn on rice maker” was in Smart devices domain and identified type of error was a “Slot Error”. Hence, preserving the domain specific data.

TABLE 2

| | Filtered output at |
|---|---|
| Output of voice assistant Knowledge | voice assistant Data |
| Graph | Retriever |
| 1. Turn on Coffee-Maker | 1. Turn on Coffee-Maker |
| 2. Turn on Rice-maker | 2. Turn on Rice-Maker |
| 3. Turn on Wifi | 3. Turn on kitchen light |
| 4. Turn on TV | 4. Turn on Ice-Maker |
| 5. Turn on kitchen light | |
| 6. Turn on alarm | |
| 7. Turn on camera | |
| 8. Turn on Ice-Maker | |

The Phonetic Correlator module further filters the valid voice assistant utterances by considering phonetic properties of the word identified by Failure Identifier module, i.e. “rice” in this case. Phonetic characteristics can be compared using known methods such as:

Double-metaphone distance[1] by converting words into their double-metaphone representation or

Word similarity[2] score using phoneme level similarity, etc.,

$$S ( {P}_{a} , {P}_{b} ) = \frac{\vert F ( {P}_{a} ) ⋂ F ( {P}_{b} ) \vert}{\vert F ( {P}_{a} ) ⋃ F ( {P}_{b} ) \vert} \qquad [ Math Figure 1 ]$$

Phonetic correlator is used to constraint the search space for correction with similar phonetic properties. To continue with our example, the output of voice assistant Data retriever is given as input to the phonetic correlator to obtain a filtered list after comparing the phonetic features of the inputs with identified error word “rice”.

TABLE 3

| Input to Phonetic Correlator | Output of Phonetic Correlator |
|---|---|
| 1. Turn on Coffee-Maker | 1. Turn on Rice-Maker |
| 2. Turn on Rice-Maker | 2. Turn on Ice-Maker |
| 3. Turn on kitchen light | |
| 4. Turn on Ice-Maker | |

The alternate hypothesis prompter module dynamically creates a prompt using the ASR n-Best hypothesis, failure type of final ASR hypothesis, word responsible for failure and retrieved voice assistant data, to query the language model to generate an improved list of hypothesis. This module will generate alternate m-Best hypothesis to correct the ASR error occurred in the actual ASR hypothesis. It is useful to get the correction in case n-Best hypothesis doesn't contain the actual user utterance. The disclosure proposes a voice assistance specific fine-tuned Language AI Model for Alternate hypothesis generation task. For example, list of alternate hypothesis would look like as below for the user input in consideration:

TABLE 4

| | Word Level | Failure | Voice assistant | |
|---|---|---|---|---|
| ASR n-Best | Confidence | Identifier | data | |
| Turn on rice | [Turn: 0.95, on: | Type: | 1. Turn on Rice- | 1. Turn on Fries |
| maker | 0.9, rice: 0.7, | Slot | Maker | Maker |
| | maker: 0.98] | Failure | 2. Turn on Ice- | 2. Turn on Slice- |
| Turn on rice | [Turn: 0.95, on: | Position/Word: | Maker | Maker |
| cooker | 0.9, rice: 0.7, | rice | | 3. Turn on |
| | maker: 0.6] | Position/Word: | | Spice-maker |
| Turn on ice | [Turn: 0.95, on: | rice | | 4. Turn on Ice- |
| maker | 0.9, ice: 0.66, | | | Maker |
| | maker: 0.98] | | | |
| Turn on price | [Turn: 0.95, on: | | | |
| maker | 0.9, rice: 0.7, | | | |
| | maker: 0.98] | | | |
| Turn on mice | [Turn: 0.95, on: | | | |
| tracker | 0.9, rice: 0.62, | | | |
| | maker: 0.55] | | | |

The reinforced ASR decoder is responsible for using the alternate m-best hypothesis along with original audio embedding to output the final 1-best corrected hypothesis. Each of the m-best hypothesis are encoded separately to a text-embedding.

### [Self-Attention]

In the self-attention layer, each hypothesis captures relationships within itself.

### [Cross Attention]

In the cross attention layer each hypothesis is compared and attends to the others to understand their relevance or importance concerning the current one.

### [Feed Forward]

The feed forward layer extracts features.

A final scoring mechanism which makes use of all intermediary outputs to determine the best hypothesis, by comparing the representations of hypothesis. The reinforced decoder uses the original audio embedding along with the alternate m-best hypothesis to select the revised and improved 1-best hypothesis. The reinforced decoder based on the alternate m-best hypothesis, text embedding, user actual utterance and audio embedding, turn on the device correctly. For example, the turn on the ICE maker.

User has provided an utterance in noisy environment or from a distant with low signal energy. This would adversely affect the ASR accuracy of the output. Noise induced errors resulting in phonetically similar sounding words can be avoided with the trigger from action execution module. For slot failure (NER failure due to matching names), in accordance with some embodiments of the disclosure. Robot-vacuum cleaner, which produces a lot of noise due to its motor functioning. User gives a command to his smart speaker home automation system to direct the cleaning process.

It may not be possible to boost the ASR to recognize each and every feature of the user specific device available in the market and thus the error generated by ASR will mostly appear to be correct for a NLP sub-system, prompting no error correction by it. However, upon execution of the command, it is possible to identify the error that had been percolated from the speech recognition. ASR detection capability can be further boosted by providing the list of available devices to the user, to re-evaluate the speech recognition, thus improving overall accuracy.

For sake of simplicity in explaining the proposal, all the previous examples use cases were for failures in only one word or one part of the user utterance. However, the errors could arise in more than one part of the user utterance. With the availability of phonetic info to the user, along with user related metadata of location (etc.), the correction for user's voice utterance can be done more effectively even at multiple parts of the user input. Even if NLP is improved, the multiple word errors could create too many combination of output to evaluate the result. Hence, it's the ASR, with the phonetic audio feature set, will be the most appropriate one to make the correct prediction of user input.

Non-native speakers tend to have erroneous pronunciation for native language word(s), especially in code-mixed language utterances. In such cases, ASR tend to fail miserably. Any stand-alone correction from NLU may not guarantee the accuracy of response to given user utterance. Our proposed system can effectively tackle such a scenario to contextually understand the user command and phonetically make a correction to it. By contextually re-evaluating with failure word along with system response, possible correction the error word is being done.

NLP sub-system of a voice intelligence is improved to correct the possible set of ASR errors. However, employing such systems also bring in the side effects of non-related corrections from NLP system, as described below. Correction from ‘touch’-> ‘Dutch’ would be possible only because of the audio features that is available to the ASR system. Otherwise, any NLP taken decision to correct the response, may erroneously impact the overall user experience

In the disclosure, the disclosure provides an efficient method for refining speech input processing, integrating an ASR, NLU, and a pre-trained AI model to detect, analyze, correct failures in real-time. Subsequently, the disclosure provides an advanced voice assistance system.

In the disclosure, in a noisy environment or due to user mispronunciation, the user input of “Turn on ICE maker” has been wrongly identified as “Turn on RICE maker” by a related art ASR system, creating a cascaded effect of error propagation in resulting a non-valid action for voice assistant. With the introduction of proposed framework, this cascaded error is identified and effectively rectified using reinforced ASR decoder backed by a AI language model.

The disclosure proposes a system to effectively reduce the overall error prone outcome of a voice assistant into an accurate & reliable result for the user utterance.

The disclosure proposes a decoder of ASR, which is capable to generate alternate 1-best hypothesis based on the phonetic information available in original user audio embedding, which is grounded by the alternate m-best hypothesis received from the previous phase. Thus, proposed solution effectively resolves the cascaded effect of error output produced by downstream modules (such as NLP) in a voice assistance.

In the disclosure, the word ‘capsule’ is used herein to describe a plurality of operation objects (such as action objects or action information) or specific domain, for example, Smart devices, and concept objects (or concept information) included in an action plan.

In the disclosure, the word ‘hypothesis’ is used herein to describe the underlying assumptions or preliminary transcriptions generated by the voice assistant devices to interpret and respond to user voice inputs.

As discussed in the background section, there is a need to provide a method and apparatus for processing a voice input. As discussed in the background section, even with the dynamic corrective capabilities of the ASR system and NLP systems, mistakes/error can still occur in processing the user voice inputs. To address such situations, the disclosure proposes a method and apparats to handle these errors effectively. The disclosure provides enhanced voice input processing by considering external factors like noisy environments and user-specific conditions, and the voice assistant device can dynamically correct errors through phonetic matching and audio decoding. The disclosure uses techniques to convert speech into both textual and audio representations, identify and categorize failures in Natural Language Understanding (NLU), and correct errors in real-time. The voice assistant device's real-time failure detection and correction capabilities ensure more accurate and responsive voice assistance, reducing the propagation of errors. The use of a pre-trained AI model addresses limitations of existing systems, providing a more precise and context-aware approach to speech input processing. The pre-trained AI model enhances adaptability and overall accuracy, leading to improved user interactions. The disclosure provides an efficient and reliable voice assistant, leading to more accurate and effective user interactions.

Various embodiments of the disclosure are hereinafter explained with reference to FIG. 1A to FIG. 6.

FIG. 1A shows an example architecture of the voice assistant device 100 for processing a voice input. The architecture comprises user 101 providing voice input via a user device, a voice assistant device 100 and electronic device 1031 to electronic device 103n (also referred to as one or more electronic devices 103). In an embodiment, the voice assistant device 100 be any device that can receive and process voice inputs/commands and perform one or more actions in response to the voice inputs/commands. In an embodiment, the voice assistant device 100 may be an independent device communicatively connected to one or more electronic devices 103. In another embodiment, the voice assistant device 100 may be embedded in the one or more electronic devices 103 and is communicatively connected to the one or more electronic devices 103. The one or more electronic devices 103 may include, but not limited to, a smartphone, laptop, tablet phone, refrigerator, fridge, TV, washing machine, music player, and the like. As an example, the one or more electronic devices 103 may be IoT devices. In yet another embodiment, the voice assistant device 100 may be associated with an intermediary device, which in turn is communicatively connected to each of the one or more electronic devices 103 to perform one or more actions corresponding to the voice input/command of the user 101, communicated by the voice assistant device 100. In another embodiment, the voice assistant device 100 may also include voice assistant enabled devices for example, with voice assistant features added/enabled in electronic devices such as televisions, smart devices, and/or automobiles, enhancing their functionality and user interaction.

In an embodiment, the voice assistant device 100 may execute an action corresponding to the received voice input from the user 101. The corresponding action may include one or more services provided to the user 101. As an example, if the voice assistant device 100 is embedded in a vehicle, the voice assistant device 100 may be communicatively connected with music system, navigation system, lighting system and so on of the vehicle. In case, the user 101 requests the voice assistant device 100 for navigating to a destination, the voice assistant device 100 may communicate with the navigation system, to execute the requested navigation service. In another example, the voice assistant device 100 may be configured in a home environment. The voice assistant device 100 may be communicatively connected with home appliances in the home environment, to control operation of the home appliances. The home appliances may be controlled based on requests from the user 101. For example, if the user 101 provides a voice input to switch ON AC, or to set temperature of the AC, the voice assistant device 100 may communicate with the AC to control operation of the AC as per the voice input.

FIG. 1B shows an example voice assistant device 100 for processing voice input, In an embodiment, the voice assistant device 100 may include at least one processor 102, memory 104, and I/O interface 106, and a transceiver 108. The at least processor 102 may include one or more processors or other processing devices and execute the OS stored in the memory 104 associated with the voice assistant device 100 in order to control the overall operation of the voice assistant device 100. The processor 102 is also capable of executing other applications resident in the memory 104, such as, one or more applications for identifying voice recognition. The processor 102 may include any suitable number(s) and type(s) of processors or other devices in any suitable arrangement. For example, the processor 102 may be capable of natural language processing, voice recognition processing, object recognition processing, and the like. In some embodiments, the processor 102 may include at least one microprocessor or microcontroller. As an example, types of the processor 102 may include, but not limited to, microprocessors, microcontrollers, digital signal processors, application specific integrated circuits, and discrete circuitry. The processor 102 may be capable of executing other processes and programs resident in the memory 104, such as operations that receive, store, and timely instruct by providing processing of various types of content. The processor 102 may be capable of moving data into or out of the memory 104 as required by an executing process.

In an embodiment, the processor 102 may be coupled to the I/O interface 106 that provides the voice assistant device 100 with the ability to connect to other devices such as the client devices or servers. For example, the voice assistant device 100 may connect to and receive applications from an external device such as a server via the I/O interface 106. The I/O interface 106 is the communication path between these accessories and the processor 102. In an embodiment, the processor 102 may be coupled to the transceiver 108 for receiving a voice input or voice command from a user 101. The voice input received by the transceiver 108 may be used by the processor 102 to execute an action corresponding to the received voice input from the user 101.

FIG. 1B shows an example architecture 110 of the voice assistant device 100 for processing a voice input. In an embodiment, the voice input received by the transceiver 108 may be used by the voice assistant device 100 for executing an action corresponding to the received voice input. The voice assistant device 100 may determine a first candidate text output from a first list of candidate text outputs or n-hypothesis (the terms ‘first list of candidate text outputs’ and ‘n-hypothesis’ may be used interchangeably throughout the disclosure) generated in response to the voice input received from the user 101. The voice assistant device 100 may validate a feasibility of executing the first candidate text output based on analysis of a first contextual data related to the first candidate text output, user-specific data, historical data related to previous validations of the voice assistant device 100 and one of an execution result or a no-action result corresponding to the first candidate text output.

In an embodiment, upon detecting that the feasibility of executing the first candidate text output is validated as not feasible for execution the voice assistant device 100 determines failure information associated with the first candidate text output. Additionally, the voice assistant device 100 may generate a second list of candidate text outputs (the terms ‘second list of candidate text outputs’ and ‘m-hypothesis’ may be used interchangeably throughout the disclosure) and corresponding text embeddings based on the failure information, the first list of candidate text outputs and second contextual data related to the user 101 and the voice assistant device 100. Additionally, the voice assistant device 100 may generate a second candidate text output or best hypothesis (the terms second candidate text output and best hypothesis used interchangeably throughout the disclosure) for the voice input from the second list of candidate text outputs based on correlation of the corresponding text embeddings of each candidate text output of the second list of candidate text outputs with an audio embedding of the voice input. Finally, the voice assistant device 100 may execute an action corresponding to the second candidate text output in response to the voice input received from the user 101. The action may include, but is not limited to, making phone calls, answering questions, translating speech, controlling smart devices, browsing the internet, taking and managing notes, etc. The voice assistant device 100 may perform various tasks through simple voice inputs. In some embodiments, such voice inputs may include, but not limited to, human inputs and automated system based inputs such as inputs from a robotic system and the like.

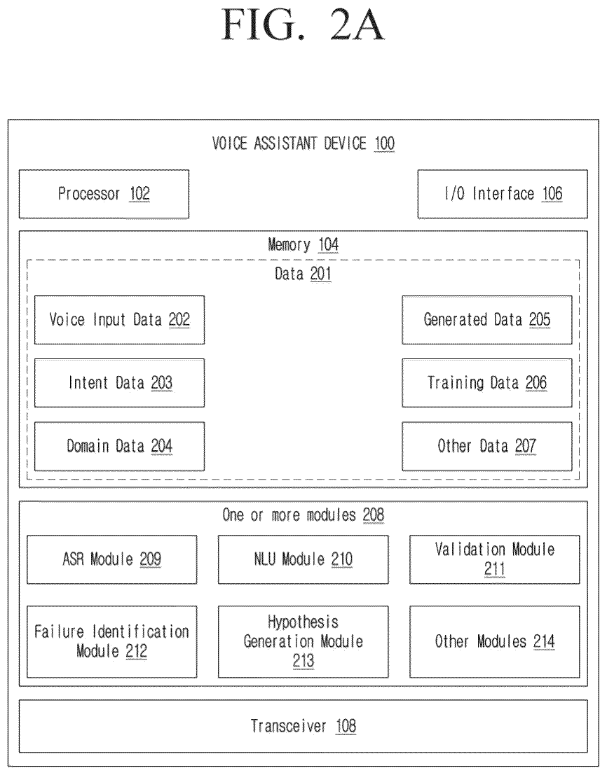

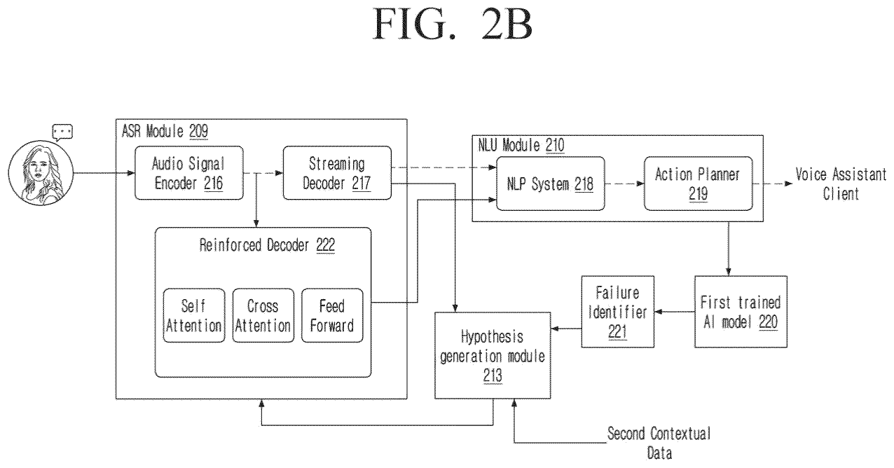

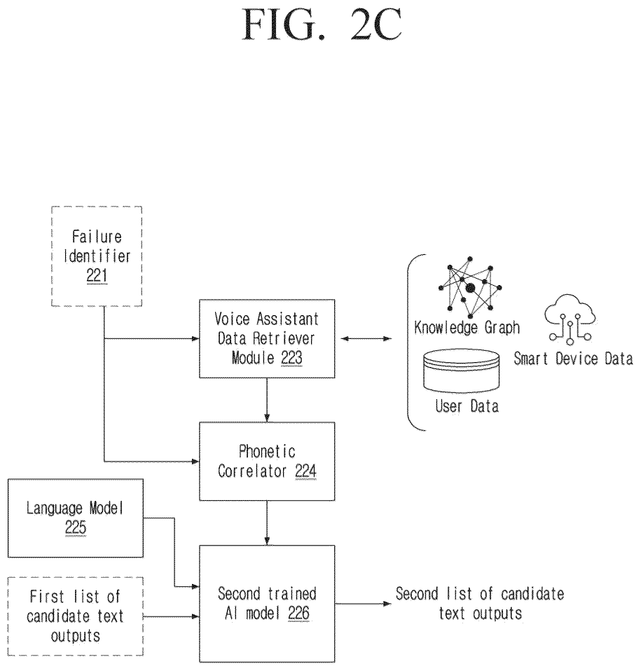

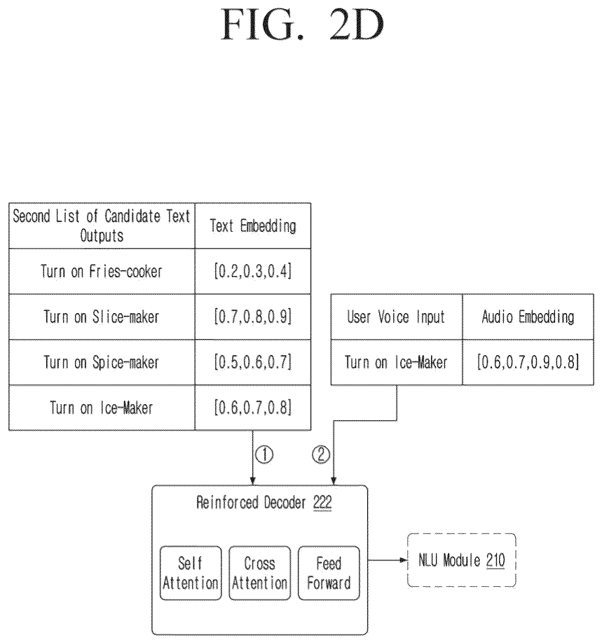

FIG. 2A shows a detailed block diagram 200 of the voice assistant device 100, in accordance with some embodiments of the disclosure.

In some implementations, the voice assistant device 100 may include a processor 102, a memory 104 and an I/O interface 106 and a transceiver 108. In an embodiment, the memory 104 may be communicatively coupled to the processor 102. The processor 102 may be configured to perform one or more functions of the voice assistant device 100, using data 201 and one or more modules 208 of the voice assistant device 100. In an embodiment, the memory 104 may store the data 201.

In an embodiment, the data 201 may include voice input data 202, intent data 203, domain data 204, generated data 205, training data 206 and other data 207. In an embodiment, the voice input data 202 may include, but not limited to, voice input or user utterance or interactions with the user 101 also referred to as dialogues processed by the processor 102 of the voice assistant device 100. In an embodiment, voice input data 202 may be provided to the processor 102, to dynamically execute an action corresponding to the voice input received from the user 101. In an embodiment, voice input data 202 may also include corresponding audio embedding of the voice input data 202. Audio embedding can be an encoding (e.g., vectorization, or vector) representing a portion of text (e.g., a phoneme, word, or the like) recognized from the voice input. The audio embedding can reflect the vocalization (or other audio representation) of a phoneme, word, etc.

In an embodiment, the intent data 203 (or intent) may convey context or meaning of at least one voice input received from the user 101. In an embodiment, an intent associated with the voice input may be identified by performing Natural Language Understanding (NLU) on the voice input data 202. In some embodiment, conversation knowledge of previous voice inputs of the voice assistant device 100 may be used to determine the intent of the received voice input. In an embodiment, the voice assistant device 100 may use this intent to perform a specific action. As an example, if the user says, “turn on the living room lights,” the voice assistant device 100, using NLU and context from previous interactions, may identify the intent is to control the smart lighting system in the living room.

In an embodiment, the domain data 204 may be referred to as specific information and context related to a particular area of interest or activity that a voice assistant device 100 may recognize and respond to. For instance, when a user 101 gives a voice command like “Order coffee,” the voice assistant device 100 may identify the “coffee ordering” domain using keywords from the user's voice input. Once a domain is identified, the voice assistant device 100 may handle various related tasks, such as asking follow-up questions to refine the order. For example, the voice assistant device 100 might respond with, “Which coffee do you want to order?” and wait for the user's additional input. In some embodiments, voice assistant device 100 may have the ability to switch between different domains and manage specific tasks within each domain. Few examples of domain data 204 may include “Smart devices”, “Calculator” for performing mathematical operations, “weather” for providing weather updates, “Music” for playing requested songs, “calendar” for managing events, etc.

In an embodiment, the generated data 205 may be referred to as data generated by the one or more modules 208 of the voice assistant device 100. As an example, the generated data may include first list of candidate text outputs generated in response to a voice input received from a user 101, failure information associated with the first candidate text output, the second list of candidate text outputs and corresponding text embeddings and the like.

In an embodiment, the training data 206 may consist of a set of data used for training the voice assistant device 100, where types of user inputs, including erroneous inputs are used. The training data 206 may include the ground truth annotations that specify the intent, domain, failure type, and slot for each kind of voice input. In some embodiments, a knowledge graph may be created using the training data 206 of voice assistant users and their corresponding response data. This knowledge graph is then used by the one or more modules 208 of the voice assistant device 100. The training data 206 enables the voice assistant device 100 to improve its accuracy and efficiency in recognizing and responding to user commands across various domains.

In some embodiments, the training data 206 may be retrieved from online data resources and/or generated through simulations. The training data 206 may be pre-processed before it is used for training. In an embodiment, the preprocessing may include annotating the retrieved data, cleaning the retrieved data to remove noise and irrelevant information, normalizing the cleaned data to a standard format, and segmenting the data into meaningful units. In some embodiments, the training data 206 may be divided into batches. Each batch may be fed into the voice assistant device 100 during the training phase for training the voice assistant device 100.

In an embodiment, the other data 207 may include metadata associated with the generated data. In some embodiments the other data 207 may be historical data corresponding to the generated data.

As used herein, the term “module” may refer to an Application Specific Integrated Circuit (ASIC), an electronic circuit, a hardware processor (shared, dedicated, or group) and memory that execute one or more software or firmware programs, a combinational logic circuit, and/or other suitable components that provide the described functionality. In an implementation, each of the one or more modules may be configured as stand-alone hardware computing units. In an embodiment, the other modules 214 may be used to perform various miscellaneous functionalities on the voice assistant device 100. It will be appreciated that, such one or more modules 208 may be represented as a single module or a combination of different modules.

In an embodiment, the data 201 may be processed by the one or more modules 208 of the voice assistant device 100. In some implementations, the one or more modules 208 may be communicatively coupled to the processor 102 for performing one or more functions of the voice assistant device 100. In implementation, the one or more modules 208 may include, without limiting to, Automatic Speech Recognition (ASR) module 209, Natural Language Understanding (NLU) module 210, validation module 211, failure identification module 212, hypothesis generation module 213, and other modules 214.

In an embodiment, the ASR module 209 may receive a voice input from the user 101. The ASR module 209 may determine the audio embedding of the voice input, text recognized from the voice input, and the first list of candidate text outputs or n-hypothesis generated for the voice input. In an embodiment, the ASR module 209 may recognize the received voice input and process the received voice input (human speech) into text.

In an embodiment, as shown in FIG. 2B, the ASR module 209 may include an audio signal encoder 216 and a streaming decoder 217. In an embodiment, the ASR module 209 may use the audio signal encoder 216 and the streaming decoder 217 to determine a first candidate text output based on the audio embedding of the voice input, text recognized from the voice input and the first list of candidate text outputs generated for the voice input. The audio signal encoder 216 may convert the raw audio signal from the user's voice input into a numerical representation known as an audio embedding. For converting user's voice input into audio embeddings, the audio signal encoder may analyze the audio signal's features, such as pitch, tone, and frequency, to create a compact and informative representation. The streaming decoder 217 may process the encoded audio signal in real-time and may convert the audio embedding into a sequence of text. The streaming decoder 217 may recognize the spoken words and generate a list of first candidate text outputs (n-hypothesis) that best matches the recognized speech. As an example, the user 101 may provide the user input “Turn on ICE Maker” for the ASR module 209 to process. Upon receiving the voice input, the audio signal encoder 216 encodes the voice input into an audio embedding, represented in the form of a numerical array [0.5, 0.7, 0.9, 0.8]. Further, the streaming decoder 217 may decode the encoded audio signal to recognize the text from the voice input. Subsequently, the streaming decoder 217 may generate a first list of candidate text outputs (n-hypothesis) based on the audio embedding.

In an embodiment, each candidate text output of the first list of candidate text outputs (n-hypothesis) may be assigned a probability that may also be referred as ASR confidence score or word level confidence score representing the likelihood that a particular set of words matches those words spoken/recited in the user voice input. The word level confidence score may be based on a number of factors including, for example, the similarity of the sound in the utterance based on data stored in the voice input data 202, or the like. Thus, each candidate text output is associated with the word level confidence score. The ASR module 209 may provide multiple or n-hypotheses (the first list of candidate text outputs) based on the word level confidence score or other score (such as probability scores, etc.). Further, the ASR module 209 may provide the most likely text recognized based on the audio voice input or a one-best hypothesis from the first list of candidate text outputs. As an example, the first list of candidate text outputs for the voice input “Turn on ICE Maker” may include,

TABLE 5
First list of candidate text outputs

Turn on rice maker
Turn on ice cooler
Turn on ice maker
Turn on price maker

In an embodiment, the ASR module 209 may employ several correction techniques to improve accuracy of the recognized voice input, when providing the first list of candidate text outputs. However, in some embodiments, due to external influences like noisy surroundings or the presence of phonetically similar words, the ASR module 209 may select the one-best hypothesis with possible errors. As an example, the selected one best hypothesis may be “Turn on rice maker”.

In an embodiment, the one-best hypothesis may be provided to the NLU module 210 from the ASR module 209. The NLU module 210 may further process the received one-best hypothesis. In an embodiment, the NLU module 210 may include a Natural Language Processing (NLP) system 218 and an action planner 219 for processing the one-best hypothesis. In an embodiment, the NLP system 218 may interpret the one-best hypothesis, extract relevant information, and understand the intent or intent data from the one-best hypothesis. The action planner 219 may use this interpreted one-best hypothesis to generate a structured plan of actions that the voice assistant device 100 needs to execute an action or NLP action corresponding to the voice input received from the user 101. The action planner 219 may map the intent to specific actions, which may include querying databases, invoking APIs, or identifying possible capsules or executing predefined functions to achieve a desired outcome. In an embodiment, the action planner 219 may provide one of an execution result or a no-action result corresponding to the first candidate text output.

In an embodiment, the NLU module 210 may also employ several correction techniques to improve the accuracy of the recognized voice input and to correct a first candidate text output. For instance, if the one-best hypothesis from ASR module 209 is generated as “dial into Doorless meeting” instead of the intended “dial into Doris's meeting,” the NLU module 210 may leverage access to the user's contact information stored on the voice assistant device 100. By matching the recognized term “Doorless” with the contact “Doris,” the NLU module 210 may correct the mistake and accurately interpret the user's intent, thereby generating an NLU hypothesis or the first candidate text output. The NLU module 210 may ensure that the voice assistant device 100 can execute the correct action, corresponding to the first candidate text output, such as “dialing into Doris's meeting”, despite the initial recognition error. However, in some embodiments, the error may not get resolved by the NLU module 210 and thus result in a wrong execution result or no-action execution result. As an example, when the selected one-best hypothesis is “Turn on rice maker,” which is the first candidate text output, since rice maker is a valid word, the NLU module 210 may not perform any error correction. Due to this, there could be two possible results, which includes a no-action execution result or a wrong execution result. For instance, when the rice maker is one of the devices associated with the voice assistant device 100, the action planner 219 may perform the action of turning on the rice maker, which is a wrong execution result as user intended to turn on ice maker through the voice input. Similarly, if the rice maker is not one of the devices associated with the voice assistant device 100, the action planner 219 may fail to execute the action corresponding to the voice input or identify possible capsules (e.g., rice maker). As a result, an error may occur in executing the first candidate text output, resulting in either an incorrect execution result or no-action result. In an embodiment, the NLU module 210 may also assign an NLU confidence score to NLU hypothesis or the first candidate text output. The NLU confidence score indicates the degree of accuracy for the NLU hypothesis or the first candidate text output.

In an embodiment, the one or more modules 208 may also include a validation module 211. In an embodiment the validation module 211 may include an execution validator or a first trained AI model 220 (the term execution validator and first trained AI model is used interchangeably throughout the description). In an embodiment, the validation module 211 may validate a feasibility of executing the first candidate text output based on analysis of a first contextual data related to the first candidate text output, user-specific data, historical data related to previous validations of the voice assistant device 100 and one of an execution result or a no-action result corresponding to the first candidate text output. In an embodiment, the execution result or the no-action result corresponding to the first candidate text output from the action planner 219 may be used by the validation module 211 to detect whether there is an error in executing the first candidate text output resulting in one of the incorrect execution result or no-action result. In an embodiment, validation module 211 may be implemented through one or more AI models. A function associated with the AI models may be performed through memory 104 and the processor 102. The processor 102 controls the processing of the input data in accordance with a predefined operating rule or the AI models stored in a non-volatile memory and a volatile memory. The predefined operating rule or artificial intelligence model may be provided through training or learning.

In an embodiment, the validation module 211 may validate the feasibility of execution through the first trained AI model 220. In an embodiment, the first trained AI model 220 may determine the first contextual data related to the first candidate text output based on analysis of the first candidate text output. In an embodiment, the first contextual data may be defined as the relevance of words within a given context. The first contextual data may comprise at least one of an intent of the first candidate text output, a slot of the first candidate text output, a word level confidence score of each word of the first candidate text output, contextual relationship between each word of the first candidate text output and a context associated with the first candidate text output, and the user's previous voice inputs to the voice assistant device 100. As an example, for the user voice input “What is the price of OnePlus® 5?”, the first candidate text output determined by the ASR module 209 may be “What is the price of 1+5?”. The first trained AI model 220 may determine the first contextual data related to the first candidate text output that is the contextual relationship between ‘price’ and ‘1+5’ (math). In the above example the first trained AI model 220 may determine that the meaning and relevance of words “What is the price of 1+5” is not a valid phrase.

In an embodiment, the validation module 211 may assign a validation confidence score to the first candidate text output through the first trained AI model 220. In an embodiment, assigning the validation confidence score to the first candidate text output may be based on the analysis of the generated first contextual data, the user-specific data, the historical data related to previous validations of the voice assistant device 100, and the execution result or the no-action result corresponding to the first candidate text output received from the action planner 219. As an example, the first trained AI model 220 may analyze the generated first contextual data related to the first candidate text output “What is the price of 1+5?”. Upon analyzing, the first trained AI model 220 may determine that the contextual relationship is not valid between the price and 1+5 (math). Thus, the generated first contextual data may affect the validation confidence score assigned to the first candidate text output. Similarly, the first trained AI model 220 may analyze the user-specific data such as location or previous interactions or the smart devices associated with the user 101 and the like, to assign validation confidence score to the first candidate text output. The first trained AI model 220 may also analyze the historical data related to previous validations of the voice assistant device 100, including any past queries in the related domain or past validations or past corrections (whether the voice input has been corrected once). In an embodiment, the historical data may be stored in a result cache associated with the voice assistant device 100. The first trained AI model 220 may further analyze the execution result or the no-action result associated with execution of the first candidate text output. Subsequently, the first trained AI model may assign the validation confidence score to the first candidate text output. In some embodiments, the first trained AI model 220 may also analyze the intent (inquiring about the price), slots (specific details like the product name “OnePlus® 5”) of the first candidate text output for assigning the validation confidence score.

In an embodiment, the first trained AI model 220 may be an AI model such as a Bidirectional Encoder Representations from Transformers (BERT) model. The BERT model may be a trained model for giving the validation confidence score of correctness for a given voice input. In an embodiment, the BERT model may be trained in a semi-supervised way, using augmented data and consistency loss. The BERT model may take a voice input as input, encodes the recognized text from the voice input to text embeddings and outputs a confidence score in the range of 0-1.

In an embodiment, the validation module 211 may compare the validation confidence score of the first candidate text output with a dynamic threshold value through the first trained AI model. In an embodiment, the dynamic threshold value may be generated for the first candidate text output based on the word level confidence score of each word of the first candidate text output and a contextual relationship between each word of the first candidate text output. As an example, for a voice input like “What is inheritance tax?”, the ASR module 209 may generate the first candidate text output as “What is inheritance tags?”, having word-level confidence scores: [What: 0.95, is: 0.9, inheritance: 0.9, tags: 0.5]. Here, the low confidence score for “tags” and the contextual mismatch (since “inheritance tags” is not a valid phrase) may result in a lower dynamic threshold. Similarly, for the voice input “Turn on Ice maker,” when the first candidate text output is “Turn on rice maker” with scores [Turn: 0.95, on: 0.9, rice: 0.8, maker: 0.98], the high word level confidence scores result in a high dynamic threshold. As discussed above, though the word level confidence is high, the NLU module 210 output has resulted in ‘no action’, which results in increasing the dynamic threshold value. This high dynamic threshold value is generated because the device name “rice maker” is generally a valid device name, and the NLU module 210 output has resulted in ‘no action’. Additionally, when the user 101 has a similarly named device, ‘ice maker,’ it may increase the confidence score of reformulation very high, thereby crossing the high threshold. The high dynamic threshold value is also maintained to ensure a high bar for correction, given the correctness of the initial hypothesis. This ensures that the voice assistant device 100 will make a correction only when correction is required. In an alternative embodiment, based on the word level confidence score and the NLU confidence score, the validation module 211 may determine the dynamic threshold.

In an embodiment, the validation module 211 may validate the feasibility of executing the first candidate text output as feasible for execution or not feasible for execution through the first trained AI model 220. In an embodiment, the feasibility of executing the first candidate text output is validated as feasible for execution when the validity confidence score of the first candidate text output is higher than or equal to the dynamic threshold value. The feasibility of executing the first candidate text output is validated as not feasible for execution when the validity confidence score of the first candidate text output is lower than the dynamic threshold value. In some embodiments, when the validity confidence score of the first candidate text output is lower than the dynamic threshold value, the validation module 211 infers that there is an error in the execution of the first candidate text output leading to a no-action result or an incorrect execution result. Hence, the feasibility of executing the first candidate text output is validated as not feasible for execution, and hence proceed with determine failure information associated with the first candidate text output.

In an embodiment, the voice assistant device 100 may include a failure identification module 212. As shown in FIG. 2B, the failure identification module 212 may include a failure identifier 221 or a trained AI classification model (the term failure identifier and trained AI classification model is used interchangeably throughout the description). In an embodiment, the failure identification module 212 may determine the failure information associated with the first candidate text output, when the feasibility of executing the first candidate text output is validated as not feasible for execution. In an embodiment, the failure information may include, but not limited to, type of failure associated with the first candidate text output, position of words responsible for the failure of the first candidate text output and a word level confidence score of each word responsible for the failure in the first candidate text output. In an embodiment, failure identifier 221 or a trained AI classification model may categorize the failure information into a type of failure. The type of the failure may include, but not limited to, a slot failure, an intent failure, a goal jump failure, and a planning failure. Table 1 given below illustrates examples of different types of failures.

TABLE 6

| | First | | | |
|---|---|---|---|---|
| | Candidate | | Word Level | Failure Identifier |
| Voice Input | Text Output | NLU Action | Confidence Score | Output |
| What is the | What is the | Capsule: | [What: 0.95, is: 0.9, | Type: Domain |
| price of | price of 1 + 5? | Calculator | the: 0.85, price: 0.9, | Failure |
| OnePlus ® 5? | | Slot: <1 + 5> | of: 0.8, 1 + 5: 0.85] | Position/Word: |
| | | | | 1 + 5 |
| What is | What is | Capsule: | [What: 0.95, is: 0.9, | Type: Domain |
| inheritance | inheritance | smart devices | inheritance: 0.9, | Failure |
| tax? | tags? | Tag slot: | tags: 0.5] | Position/Word: |
| | | <Inheritance | | tags |
| | | tags> | | |
| How do you | How do you | Capsule: | [How: 0.95, do: 0.9, | Type: Goal |
| say Thank | say Thank | Voice | you: 0.9, say: 0.85, | Failure |
| you in Dutch? | you in touch? | assistant Chat | Thank: 0.96, | Position/Word: |
| | | Goal: | you: 0.85, in: 0.9, | touch |
| | | Greetings | touch: 0.55] | |
| | | Response | | |
| Turn on Ice | Turn on rice | Capsule: | [Turn: 0.95, on: 0.9, | Type: Slot |
| maker | maker | smart devices | rice: 0.7, maker: 0.98] | Failure |
| | | Device: Rice | | Position/Word: |
| | | maker | | rice |
| Order a black | Order a black | Capsule: | [Order: 0.95, a: 0.98, | Type: Slot |
| coffee with | coffee with | Shopping | black: 0.9, | Failure |
| croissant | crescent | Tag Slot: | coffee: 0.85, | Position/Word: |
| | | Cresent | with: 0.8, | crescent |
| | | | crescent: 0.6] | |
| Actually, can | Actually, can | Capsule: | [Actually: 0.9, | Type: Planning |
| you play | you play | None | can: 0.9, you: 0.9, | Failure |
| some Jazz | some Jazz | | play: 0.9, some: 0.85, | Position/Word: |
| music instead | music in bed | | Jazz: 0.7, music: 0.75, | in bed |
| | | | in bed: 0.5] | |

As discussed in Table 6 above, the type of failure identified by the failure identification module 212 may be domain failure when the NLU module 210 mistakes the domain of the voice input received from the user 101. For example, the voice input is, “What is the price of OnePlus® 5?” but the first candidate text output generated by the ASR module 209 may be, “What is the price of 1+5?”, which leads to a domain failure because the NLU module 210 incorrectly identifies the context as a mathematical calculation instead of a product inquiry. In an embodiment, goal failure may occur when the NLU module 210 fails to achieve the user's intended goal. For instance, the voice input is, “How do you say, Thank you in Dutch?” but the first candidate text output generated by the ASR module 209 is, “How do you say Thank you in touch,” which leads to a goal failure because the NLU module 210 incorrectly provides greetings response instead of providing the translation. This response indicates a goal failure because the NLU module 210 did not fulfill the user's request for a translation.

In an embodiment, the type of failure may be classified as slot failure by the failure identification module 212 when for the voice input “Order a black coffee with croissant”, the first candidate text output generated by the ASR module 209 is “Order a black coffee with crescent”. For the voice input “Order a black coffee with croissant”, the slot would be ‘Black coffee’ and ‘Croissant’. The ASR module 209 misinterprets “croissant” as “crescent,” leading to a slot failure. The type of failure may be planning failure, when for the voice input “Actually, can you play some Jazz music instead” the first candidate text output generated by the ASR module 209 is “Actually, can you play some Jazz music in bed” resulting in a planning failure.

In an embodiment the voice assistant device 100 may include the hypothesis generation module 213. In an embodiment, the hypothesis generation module 213 may generate a second list of candidate text outputs and corresponding text embeddings based on the failure information, the first list of candidate text outputs and second contextual data related to the user 101 and the voice assistant device 100.

FIG. 2C illustrates a detailed block diagram of the hypothesis generation module 213. In an embodiment, the hypothesis generation module 213 may include a voice assistant data retriever module 223, a phonetic correlator 224, a language model 225 and an intelligent hypothesis generator or a second trained AI model 226. In an embodiment, the voice assistant data retriever module 223 may retrieve contextually, and semantically closest matching valid candidates related to the voice input received from the user 101 from one or more sub systems associated with the voice assistant data retriever module 223. In an embodiment, the one or more sub systems may generate the second contextual data related to the user 101 and the voice assistant device 100, which includes a Knowledge Graph (KG), user data, and smart device data. The knowledge graph may be created out of all the valid voice inputs and responses of voice assistant devices 100. The knowledge graph may be obtained from generic user data collected from millions of voice assistant devices 100. Entries are added to the knowledge graph only after the query and responses are found to be valid for voice assistant device 100 operations. As an example, the user data may include the user's personal data such as contact names, application names, region, locale, profile data, and the like, which is useful to correctly identify the phonetic errors associated with the user's voice input. The smart device data may include, but not limited to, data related to the smart devices associated with the user 101 and Internet of Things (IoT) data of the user 101, which is also useful in accurately identifying errors in the user's voice inputs.

In an embodiment, the failure information from the failure identifier 221 may be provided to the voice assistant data retriever module 223. The type of failure and the word responsible for failure identified in the first candidate text output may be passed to the voice assistant data retriever module 223 to get contextually and semantically closest matching valid data related to the voice input received from the user 101. As an example, as shown in Table 7 below, for the voice input: “Turn on ICE maker”, the generated first candidate text output is: “Turn on rice maker”. In this scenario, the voice assistant data retriever module 223 may query the KG with “Turn on” capability voice inputs for supported valid voice assistant voice inputs and responses. In response to the query the KG may provide one or more outputs as shown in Table 7 below.

TABLE 7

| First candidate | | |
|---|---|---|
| text output | Failure Information | KG Outputs |
| Turn on rice maker | Type: Slot Failure | 1. Turn on Coffee-Maker |
| | Position/Word: rice | 2. Turn on Rice-maker |
| | | 3. Turn on Wifi |
| | | 4. Turn on TV |
| | | 5. Turn on kitchen light |
| | | 6. Turn on alarm |
| | | 7. Turn on camera |
| | | 8. Turn on Ice-maker |

In an embodiment, after obtaining the output from the KG, the voice assistant data retriever module 223 may filter the KG outputs using the user data, and the smart device data related to the user 101, as shown in Table 8. The smart device data may be available on the cloud server associated with the voice assistant device 100. For filtering the KG outputs the smart device data may be used because the generated first candidate text output “Turn on rice maker” is in the “Smart devices” domain, and the identified type of error was a “Slot Error.”

TABLE 8

| Output of the Knowledge | Filtered output at voice assistant data retriever |
|---|---|
| Graph | module |
| 1. Turn on Coffee-Maker | 1. Turn on Coffee-Maker |
| 2. Turn on Rice-maker | 2. Turn on Rice-Maker |
| 3. Turn on Wifi | 3. Turn on kitchen light |
| 4. Turn on TV | 4. Turn on Ice-Maker |
| 5. Turn on kitchen light | |
| 6. Turn on alarm | |
| 7. Turn on camera | |
| 8. Turn on Ice-Maker | |

In an embodiment, the hypothesis generation module 213 may include a phonetic correlator 224. The failure information from the failure identifier 221 and the filtered output from the voice assistant data retriever module 223 may be provided to the phonetic correlator 224. The phonetic correlator 224 may further filter the output from the voice assistant data retriever module 223 by considering the phonetic properties of the word identified by the failure identifier 221, i.e., “rice” in the above example. In an embodiment, the phonetic properties of the word may be determined using Double Metaphone distance by converting words into their Double Metaphone representation or word similarity score using phoneme-level similarity. For example, the following mathematical equation may be used for measuring the similarity and diversity of the words.

$$S ( {P}_{a} , {P}_{b} ) = \frac{F ( {P}_{a} ) ⋂ F ( {P}_{b} )}{F ( {P}_{a} ) ⋃ F ( {P}_{b} )} \qquad [ Math Figure 2 ]$$

The Phonetic Similarity ‘S’ between a pair of phonemes P_(a) and P_(b) is measured by using the feature set F(·) of two phonemes and computing Jaccard similarity. In an embodiment, the phonetic correlator 224 may be useful to constrain the search space for correction with similar phonetic properties.

As shown in Table 9 below, the output of the voice assistant data retriever module 223 is given as input to the phonetic correlator 224 to obtain a filtered list after comparing the phonetic features of the inputs with the identified error word “rice”

TABLE 9

| Input to Phonetic Correlator | Output of Phonetic Correlator |
|---|---|
| 1. Turn on Coffee-Maker | 1. Turn on Rice-Maker |
| 2. Turn on Rice-Maker | 2. Turn on Ice-Maker |
| 3. Turn on kitchen light | |
| 4. Turn on Ice-Maker | |

In an embodiment, the hypothesis generation module 213 may include the second trained AI model 226. The second trained AI model 226 may generate a second list of candidate text outputs or an alternate list of hypotheses, i.e., m-hypotheses. In an embodiment, the first list of candidate text outputs (n-hypotheses), along with the word-level confidence score, the type of failure, and the word responsible for the failure identified in the first candidate text output, and the output of the phonetic correlator, may be provided to the second trained AI model 226. Subsequently, the second trained AI model 226 may generate an improved list of hypotheses using the language model 225. In an embodiment, the language model 225 may be a Large Language Model (LLM) using generative AI to enhance the voice assistant device's capabilities. In an embodiment, the language model 225 may generate the second list of candidate text outputs (m-hypotheses) and corresponding text embeddings.

As an example, the second list of candidate text outputs would look like as shown in Table 10 below:

TABLE 10

| Query to the Language Model | | | | |
|---|---|---|---|---|
| First list of | | | Output of | Language |
| candidate text | Word Level | Failure | Phonetic | Model |
| outputs | Confidence | Identifier | Correlator | Output |
| Turn on rice | [Turn: 0.95, on: | Type: Slot | 1. Turn on | 1. Turn on |
| maker | 0.9, rice: 0.7, | Failure | Rice-Maker | Fries Maker |
| | maker: 0.98] | Position/Word: | 2. Turn on Ice- | 2. Turn on |
| Turn on rice | [Turn: 0.95, on: | rice | Maker | Slice-Maker |
| cooker | 0.9, rice: 0.7, | | | 3. Turn on |
| | cooker: 0.6] | | | Spice-maker |
| Turn on ice | [Turn: 0.95, on: | | | 4. Turn on |
| maker | 0.9, ice: 0.66, | | | Ice-Maker |
| | maker: 0.98] | | | |
| Turn on price | [Turn: 0.95, on: | | | |
| maker | 0.9, price: 0.7, | | | |
| | maker: 0.98] | | | |
| Turn on mice | [Turn: 0.95, on: | | | |
| tracker | 0.9, mice: 0.62, | | | |
| | tracker: 0.55] | | | |

In an embodiment, the second list of candidate text outputs (m-hypothesis) generated by the hypothesis generation module 213 may include a plurality of candidate text outputs phonetically similar to text recognized from the voice input.

In an embodiment, the second list of candidate text outputs (alternate m-hypothesis) and corresponding text embeddings generated by the hypothesis generation module 213 may be further provided to the ASR module 209 for determining a second candidate text output for the voice input from the second list of candidate text outputs. In an embodiment, the ASR module 209 may also include a reinforced decoder 222 for determining the second candidate text output for the voice input from the second list of candidate text outputs. In an embodiment, the reinforced decoder 222 may be a third trained AI model. In an embodiment, the second candidate text output may be determined based on correlation of the corresponding text embeddings of each candidate text output of the second list of candidate text outputs with an audio embedding of the voice input.

In an embodiment, the reinforced decoder 222 may include three layers a self-attention layer, a cross-attention and a feed forward layer. In an embodiment, the reinforced decoder 222 may determine self-attention data based on text embeddings of each of a plurality of candidate text outputs in the second list of candidate text outputs. Further, cross-attention data based on text embeddings of each of the plurality of candidate text outputs in the second list of candidate text outputs and the audio embedding of the voice input, may be determined by the reinforced decoder 222. Subsequently, the reinforced decoder 222 may assign an attention score for each of the plurality of candidate text outputs in the second list of candidate text outputs based on the determined self-attention data and the cross-attention data. Finally, the reinforced decoder 222 may determine the second candidate text output for the voice input from the plurality of candidate text outputs in the second list of candidate text outputs based on the attention score.

FIG. 2D illustrates a detailed block diagram of the reinforced decoder 222. In an embodiment, the second candidate text output may be determined based on correlation of the corresponding text embeddings of each candidate text output of the (1) second list of candidate text outputs with an audio embedding of the (2) voice input, by the reinforced decoder 222. In an embodiment, the self-attention layer may process the text embeddings of each candidate text output in the second list of candidate text outputs independently. The self-attention layer may capture internal relationships within each candidate text outputs, as self-attention data. Table 6 illustrates an example determining the second candidate text output for the voice input from the second list of candidate text outputs. As shown in Table 6, the self-attention layer, for the candidate text output “Turn on Fries-cooker”: The self-attention scores are [0.22, 0.74, 0.85]. This indicates that the self-attention layer has given higher importance to certain parts of the text, such as the word “on” and the device name “Fries Cooker.” In an embodiment, the cross-attention layer may integrate audio embeddings with text embeddings to evaluate how well each candidate text outputs in the second list of candidate text outputs matches the audio input, for determining cross-attention data. The cross-attention layer may assign higher weights to parameters like “ice” based on their correlation with the audio embedding. As an example, for the candidate text output “Turn on Ice-Maker” the cross-attention scores are [0.92, 0.93, 0.96, 0.88, 0.94]. Here, the cross-attention layer has given significant weight to the correlation between the audio embedding and the text, especially for the word “ice.”

In an embodiment, the feed-forward layer processes the integration from the self-attention and cross-attention layer to produce final scores for each candidate text outputs. As an example, for the candidate text output “Turn on Ice-Maker” the final score is 0.96, making it the highest among the candidates text outputs. The final scores reflect how well each candidates text outputs matches the voice input, with “Ice-maker” being the most accurate match based on the attention scores from both the self-attention and cross-attention layers. Thus, “Turn on Ice-Maker” is the determined second candidate text output for the voice input from the plurality of candidate text outputs in the second list of candidate text outputs based on the attention score.

TABLE 11

| Second list of | | | | | |
|---|---|---|---|---|---|
| candidate | Text | Audio | | | Feed |
| text outputs | Embedding | Embedding | Self-Attention | Cross Attention | Forward |
| Turn on Fries- | [0.2, 0.3, 0.4] | [0.6, 0.7, 0.9, 0.8] | [0.22, 0.74, | [0.89, 0.92, 0.65, | 0.65 |
| cooker | | | 0.43, 0.6, 0.85] | 0.57, 0.95] | |
| Turn on Slice- | [0.7, 0.8, 0.9] | [0.6, 0.7, 0.9, 0.8] | [0.26, 0.77, | [0.93, 0.94, 0.75, | 0.77 |
| maker | | | 0.39, 0.63, | 0.85, 0.93] | |
| | | | 0.81] | | |
| Turn on | [0.5, 0.6, 0.7] | [0.6, 0.7, 0.9, 0.8] | [0.21, 0.74, | [0.91, 0.94, 0.85, | 0.84 |
| Spice-maker | | | 0.45, 0.59, | 0.84, 0.91] | |
| | | | 0.83] | | |
| Turn on Ice- | [0.6, 0.7, 0.8] | [0.6, 0.7, 0.9, 0.8] | [0.23, 0.76, | [0.92, 0.93, 0.96, | 0.93 |
| Maker | | | 0.42, 0.61, | 0.88, 0.94] | |
| | | | 0.87] | | |

In an embodiment, the determined second candidate text output for the voice input may be provided to the NLU module 210. In an embodiment, the second candidate text output may be executed when the feasibility of execution of the second candidate text output is validated as feasible for execution. When the feasibility of execution of the second candidate text is validated as feasible, the voice assistant device 100, through its voice assistant client, may execute an action corresponding to the second candidate text output in response to the voice input received from the user 101.

In an embodiment, the voice assistant device 100 may include other modules. The other modules may include a training module. In some embodiments the other modules may also include a data collection module.

In an embodiment, the voice assistant device 100 may be trained by the training module for processing voice input received from the user 101. In embodiment, the first trained AI model 220, such as a BERT model, is designed to provide a validation confidence score for the correctness of a given voice input. The BERT model may be trained in a semi-supervised manner, utilizing augmented data and consistency loss to enhance its accuracy. Additionally, the intelligent hypothesis generator or a second trained AI model 226 generates a second list of candidate text outputs. The training module may train the second trained AI model 226 using the training data 206.

In an embodiment, the ASR module 209 includes the reinforced decoder 222, which is a third trained AI model. The reinforced decoder 222 may be trained by the training module to determine the second candidate text output from the second list of candidate text outputs by correlating the text embedding with the audio embedding of the voice input. The failure identifier 221, or a trained AI classification model (multi-class classification model) is trained to categorize failure information into types such as slot failure, intent failure, goal jump failure, and planning failure. The one or more modules 208 of the voice assistant device 100 may be trained by the training module to process voice input received from the user 101, ensuring accurate and efficient voice recognition and response.

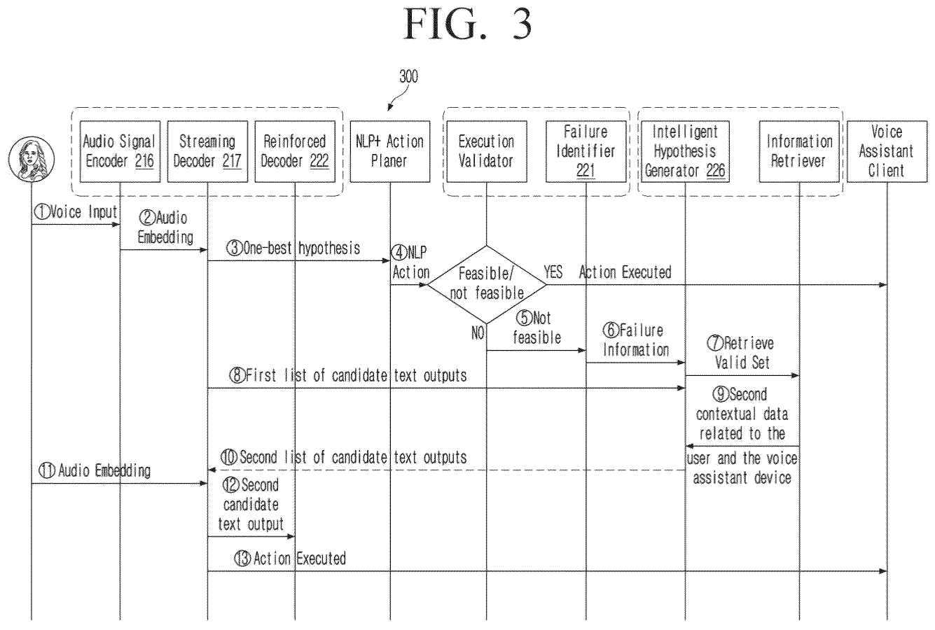

FIG. 3 is a sequence diagram illustrating a method 300 of processing voice input in a voice assistant device 100. In an embodiment, at step (1) the voice assistant device 100 may receive a voice input from a user 101. At step (2) the audio signal encoder 216 may convert the raw audio signal from the voice input into a numerical representation known as an audio embedding. At step (3) streaming decoder 217 may generate a first list of candidate text outputs (n-hypothesis) based on the audio embedding and recognized text and transmit a one-best hypothesis as output to the NLU module 210 (NLP+action planner). At step (4) the action planner 219 may use the first candidate text output (the one-best hypothesis with correction or no correction by the NLU module 210) to generate an NLP action that the voice assistant device 100 needs to execute. At step (5) the execution validator may validate the feasibility of executing the first candidate text output as feasible for execution or not feasible for execution. When the first candidate text output is feasible for execution the action corresponding to the first candidate text output is executed through the voice assistant client.

When the first candidate text output is not feasible for execution the failure identifier may determine the failure information associated with the first candidate text output. At step (6) the failure identifier 221 determines the failure information associated with the first candidate text output. At step (7) the intelligent hypothesis generator 226 may retrieve the valid set from an information retriever (filtered output of voice assistant data retriever module). At step (10) the intelligent hypothesis generator 226 may generate a second list of candidate text outputs and corresponding text embeddings based on the (6) failure information, (8) the first list of candidate text outputs and (9) second contextual data related to the user 101 and the voice assistant device 100. At step (11) the audio signal encoder 216 may provide the audio embedding to the reinforced decoder 222. At step (12) the reinforced decoder 222 may determine a second candidate text output for the voice input based on the second list of candidate text outputs and the audio embedding of the voice input. At step (13) the execution validator may validate the feasibility of executing the second candidate text output as feasible for execution or not feasible for execution. Upon determining that the second candidate text output is feasible for execution the action corresponding to the second candidate text output is executed through the voice assistant client. Thus, when the first candidate text output is not feasible for execution, the first candidate text output gets corrected in a loop by means of reinforcing reinforcement learning.

In an embodiment, when the feasibility of executing the second candidate text output is validated as not feasible for execution the voice assistant device 100 may determine subsequent candidate text outputs consecutively according to the steps (1) to (11). In an embodiment, when the feasibility of executing the second candidate text output is validated as not feasible for execution, the voice assistant device 100 may determine subsequent candidate text outputs until one of: the feasibility of executing one of the subsequent candidate text outputs is determined as feasible for execution; or number of validations of the subsequent candidate text outputs exceeds a predefined threshold number of validations.

In an embodiment, if the first candidate text output gets correct once to generate second candidate text output, the result cache holds the metadata associated with the first candidate text output and checks if the first candidate text output has been corrected once. If the first candidate text output has already been corrected, the result cache may take the corrected first candidate text output so that the voice assistant device 100 does not go in a loop of correction, thereby helping in preventing latency increase.

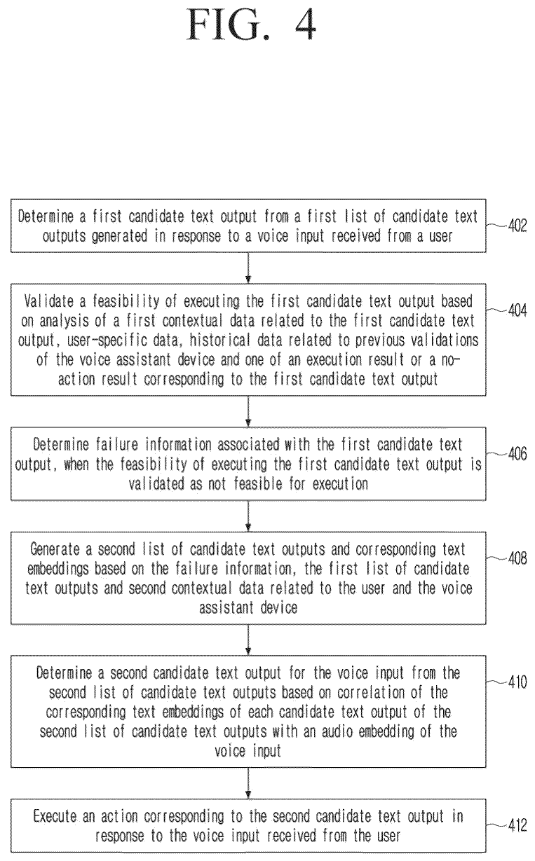

FIG. 4 shows an example flowchart illustrating a method of processing voice input in a voice assistant device 100 using the processor 102 configured in the voice assistant device 100. The method 400 may be described in the context of computer executable instructions. Computer executable instructions can include routines, programs, objects, components, data structures, procedures, modules, and functions, which perform specific functions or implement specific abstract data types.

The order in which the method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 402, the method 400 includes determining, by a processor 102, a first candidate text output from a first list of candidate text outputs generated in response to a voice input received from a user 101. In an embodiment, the first candidate text output may be determined based on the audio embedding of the voice input, text recognized from the voice input and the first list of candidate text outputs generated for the voice input based on the audio embedding of the voice input and the text recognized from the voice input.

At block 404, the method 400 includes validating, by the processor 102, a feasibility of executing the first candidate text output based on analysis of a first contextual data related to the first candidate text output, user-specific data, historical data related to previous validations of the voice assistant device 100 and one of an execution result or a no-action result corresponding to the first candidate text output. In an embodiment, validating the feasibility of execution may include generating, through a first trained AI model 220, the first contextual data related to the first candidate text output based on analysis of the first candidate text output. Subsequently, assigning, through the first trained AI model 220, a validation confidence score to the first candidate text output based on the analysis of the generated first contextual data, the user-specific data, and the historical data related to previous validations of the voice assistant device 100. Validating the feasibility of execution, further includes comparing, through the first trained AI model 220, the validation confidence score of the first candidate text output with a dynamic threshold value, where the dynamic threshold value is generated for the first candidate text output based on word level confidence score of each word of the first candidate text output and a contextual relationship between each word of the first candidate text output. Additionally, validating, through the first trained AI model 220, the feasibility of executing the first candidate text output as feasible for execution or not feasible for execution. In an embodiment, the feasibility of executing the first candidate text output is validated as feasible for execution when the validity confidence score of the first candidate text output is higher than or equal to the dynamic threshold value. Alternatively, the feasibility of executing the first candidate text output is validated as not feasible for execution when the validity confidence score of the first candidate text output is lower than the dynamic threshold value.

At block 406, the method 400 includes determining, by the processor 102, failure information associated with the first candidate text output, when the feasibility of executing the first candidate text output is validated as not feasible for execution. In an embodiment, the failure information is determined by a trained AI classification model and the failure information comprises at least one of type of failure associated with the first candidate text output, position of words responsible for the failure of the first candidate text output and a word level confidence score of each word responsible for the failure in the first candidate text output.

At block 408, the method 400 includes generating by a processor 102 a second list of candidate text outputs and corresponding text embeddings based on the failure information, the first list of candidate text outputs and second contextual data related to the user 101 and the voice assistant device 100.

At block 410, the method 400 includes determining by a processor 102 a second candidate text output for the voice input from the second list of candidate text outputs based on correlation of the corresponding text embeddings of each candidate text output of the second list of candidate text outputs with an audio embedding of the voice input. In an embodiment, determining the second candidate text output from the second list of candidate text outputs by a third trained AI model includes determining self-attention data based on text embeddings of each of a plurality of candidate text outputs in the second list of candidate text outputs. Further, determining cross-attention data based on text embeddings of each of the plurality of candidate text outputs in the second list of candidate text outputs and the audio embedding of the voice input. Furthermore, assigning an attention score for each of the plurality of candidate text outputs in the second list of candidate text outputs based on the determined self-attention data and the cross-attention data. Subsequently, determining the second candidate text output includes determining the second candidate text output for the voice input from the plurality of candidate text outputs in the second list of candidate text outputs based on the attention score.

At block 412, the method 400 includes executing by a processor 102 an action corresponding to the second candidate text output in response to the voice input received from the user 101.

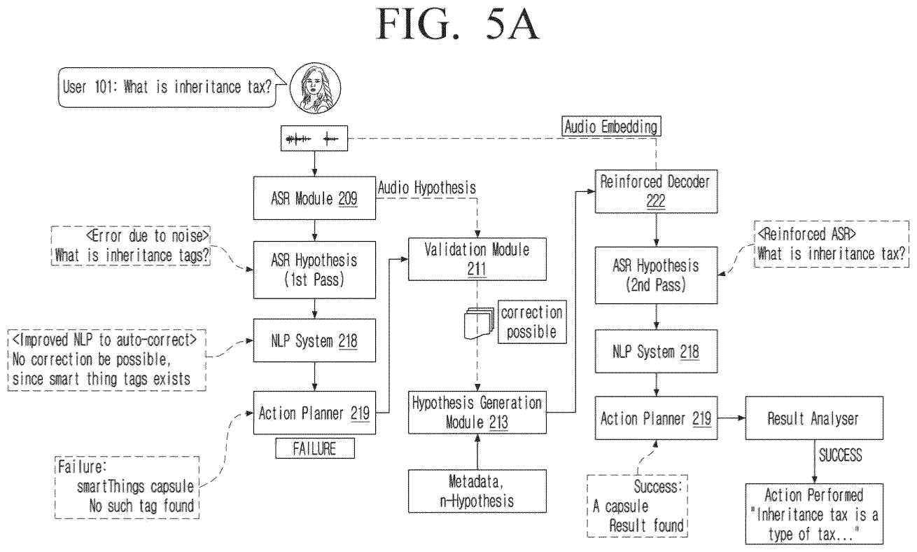

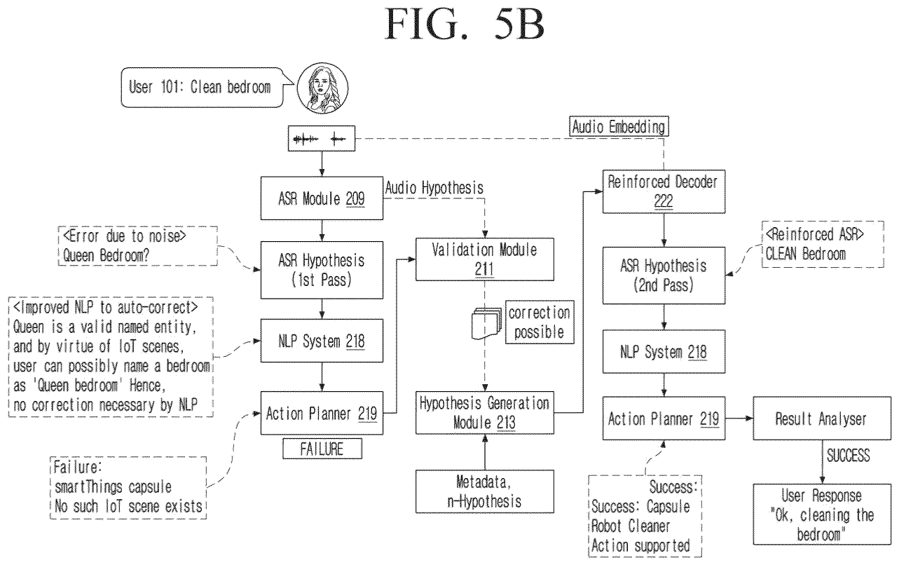

FIG. 5A shows a flowchart illustrating an example scenario of processing a voice input in voice assistant devices 100, according to the embodiments of the disclosure. In an embodiment, the ASR module 209 receives a voice input “What is inheritance tax” from the user 101. The ASR module 209 uses the audio signal encoder 216 and the streaming decoder 217 to determine a one-best hypothesis (ASR Hypothesis first pass). The one-best hypothesis determined is “What is inheritance tags”. Further, the one-best hypothesis is provided to the NLU module 210 from the ASR module 209. The NLU module 210 includes the NLP system 218 and the action planner 219 for processing the one-best hypothesis. The NLP system 218 interprets the one-best hypothesis, extracts relevant information, and understands the intent from the one-best hypothesis to generate a first candidate text output. As ‘tag’ is a valid term, the NLP system 218 interprets ‘What is inheritance tags’ as a valid command. The action planner 219 maps the intent to specific actions, and identifies possible capsules as Smarthings due to ‘tags’ keyword to achieve a desired outcome. However, the action planner 219 fails to identify the possible action, since in Smart devices capsule no such tags as ‘inheritance tags’ are found. Thereafter, the validation module 211 validates the feasibility of execution of the first candidate text output, and validates that the first candidate text output is not feasible for execution. Upon validation as not feasible for execution, the failure identification module 212 determines the failure information associated with the first candidate text output. In this example scenario, the type of failure identified by the failure identification module 212 is domain failure because the term “tags” in this context, leads to domain failure. Further, the hypothesis generation module 213 generates a second list of candidate text outputs (m-hypothesis) and corresponding text embeddings based on the failure information, the first list of candidate text outputs and second contextual data related to the user 101 and the voice assistant device 100. The m-hypothesis may be provided to the reinforced decoder 222 for determining the second candidate text output, i.e. “What is inheritance tax” for the voice input from the second list of candidate text outputs. Further, the NLP system 218 and the action planner 219 process the second candidate text output. Upon determining that the second candidate text output is feasible (success) for execution, the action corresponding to the second candidate text output is executed through the voice assistant client.

FIG. 5B shows a flowchart illustrating another example scenario of processing a voice input in voice assistant devices 100, according to the embodiments of the disclosure. In an embodiment, the ASR module 209 receives a voice input “Clean Bedroom” from the user 101. The ASR module 209 uses the audio signal encoder 216 and the streaming decoder 217 to determine a one-best hypothesis (ASR Hypothesis first pass). The one-best hypothesis determined is “Queen Bedroom”. Further, the one-best hypothesis is provided to the NLU module 210 from the ASR module 209. The NLU module 210 includes the NLP system 218 and the action planner 219 for processing the one-best hypothesis. The NLP system 218 interprets the one-best hypothesis, extract relevant information, and understand the intent from the one-best hypothesis to generates a first candidate text output. As Queen is a valid name, and also by virtue of IoT scenes, the user 101 may possibly name a bedroom as ‘Queen bedroom’, hence, the NLP system 218 interprets ‘Queen bedroom’ as a valid command. The action planner 219 maps the intent to specific actions, and identifies possible capsules to achieve a desired outcome. However, the action planner 219 fails to identify the possible capsules, since in Smart devices there is no such IoT scene as ‘Queen bedroom’. Thereafter the validation module 211 validates the feasibility of execution of the first candidate text output, and validates that the first candidate text output is not feasible for execution. Upon validation as not feasible for execution, the failure identification module 212 determines the failure information associated with the first candidate text output. In this example scenario, the type of failure identified by the failure identification module 212 is slot failure as the word “clean” is misinterpreted as “queen,”. Further, the hypothesis generation module 213 generates a second list of candidate text outputs (m-hypothesis) and corresponding text embeddings based on the failure information, the first list of candidate text outputs and second contextual data related to the user 101 and the voice assistant device 100. The m-hypothesis may be provided to the reinforced decoder 222 for determining the second candidate text output, i.e. “Clean bedroom” for the voice input from the second list of candidate text outputs. Further, the NLP system 218 and the action planner 219 processes the second candidate text output. Upon determining that the second candidate text output is feasible (success) for execution, the action (turn-on robot-cleaner) corresponding to the second candidate text output is executed through the voice assistant client.

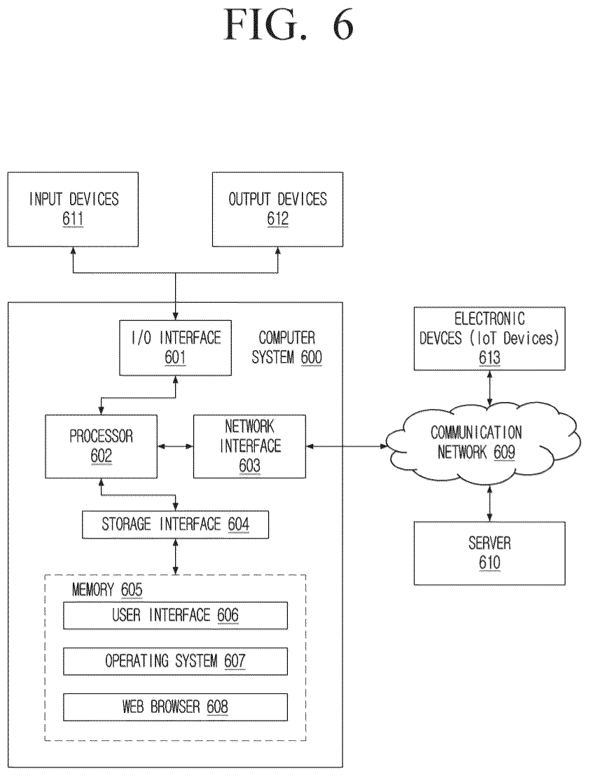

FIG. 6 is a block diagram of an example computer system for implementing embodiments consistent with the disclosure.

In some embodiments, FIG. 6 illustrates a block diagram of an example computer system 600 for implementing embodiments. In some embodiments, the example computer system 600 may be a voice assistant device 100 for processing voice input. As an example, the voice assistant device 100 may include, but not limited to, devices that have capability of receiving and processing voice based inputs and providing voice based responses such as a mobile device, a laptop, a palmtop, a desktop, a mobile phone, a smart phone, Personal Digital Assistant (PDA), a tablet, a wearable device, an Internet of Things (IoT) device, a virtual reality device, a foldable device, a flexible device, a display device, or an immersive system. The example computer system 600 may include a central processing unit (“CPU” or “processor”) 602. The processor 602 may include at least one data processor for executing program components for executing user or system-generated business processes. The processor 602 may include specialized processing units such as integrated system (bus) controllers, memory management control units, floating point units, graphics processing units, digital signal processing units, etc.

The processor 602 may be disposed in communication with input devices 611 and output devices 612 via I/O interface 601. The I/O interface 601 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc. Using the I/O interface 601, example computer system 600 may communicate with input devices 611 and output devices 612 and a server 610. The example computer system 600 may also communicate with electronic devices such as Internet of Things (IoT) Devices 613, for controlling the IoT devices 613 based on the voice input received from the user 101.

In some embodiments, the processor 602 may be disposed in communication with a communication network 609 via a network interface 603. The network interface 603 may communicate with the communication network 609. The network interface 603 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 603 and the communication network 609, the example computer system 600 may communicate with the voice assistant device 100, for which examples are mentioned in description of FIG. 1. The communication network 609 can be implemented as one of the different types of networks, such as intranet or Local Area Network (LAN), Closed Area Network (CAN) and such from the voice assistant device 100. The communication network 609 may either be a dedicated network or a shared network, which represents an association of the different types of networks that use a variety of protocols, for example, Hypertext Transfer Protocol (HTTP), CAN Protocol, Transmission Control Protocol/Internet Protocol (TCP/IP), Wireless Application Protocol (WAP), etc., to communicate with each other. Further, the communication network 609 may include a variety of network devices, including routers, bridges, servers, computing devices, storage devices, etc. In some embodiments, the processor 602 may be disposed in communication with a memory 605 (e.g., RAM, ROM, etc.) via a storage interface 604. The storage interface 604 may connect to memory 605 including, without limitation, memory drives, removable disc drives, etc., employing connection protocols such as Serial Advanced Technology Attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 605 may store a collection of program or database components, including, without limitation, a user interface 605, an operating system 607, a web browser 608 etc. In some embodiments, the example computer system 600 may store user/application data, such as the data, variables, records, etc. Such databases may be implemented as fault-tolerant, relational, scalable, secure databases such as Oracle or Sybase.

The operating system 607 may facilitate resource management and operation of the example computer system 600. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/6/8, 10 etc.), APPLE® IOS®, GOOGLE™ ANDROID™, BLACKBERRY® OS, or the like. The User interface 606 may facilitate display, execution, interaction, manipulation, or operation of program components through textual or graphical facilities. For example, user interfaces may provide computer interaction interface elements on a display system operatively connected to the example computer system 600, such as cursors, icons, check boxes, menus, scrollers, windows, widgets, etc. Graphical User Interfaces (GUIs) may be employed, including, without limitation, Apple® Macintosh® operating systems' Aqua®, IBM® OS/2®, Microsoft® Windows® (e.g., Aero, Metro, etc.), web interface libraries (e.g., ActiveX®, Java®, Javascript®, AJAX, HTML, Adobe® Flash®, etc.), or the like.

In some embodiments, the example computer system 600 may implement the web browser 608 stored program components. The web browser 608 may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers 608 may utilize facilities such as AJAX, DHTML, ADOBE® FLASH®, JAVASCRIPT®, JAVA®, Application Programming Interfaces (APIs), etc. In some embodiments, the example computer system 600 may implement a mail server stored program component. The mail server may be an Internet mail server such as Microsoft Exchange, or the like. The mail server may utilize facilities such as Active Server Pages (ASP), ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the example computer system 600 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

The disclosure provides a method and system for processing voice input in a voice assistant device. One or more embodiments handle errors effectively, even with the dynamic corrective capabilities of the ASR and NLP systems. Despite the ASR and NLP systems having error correction capabilities, mistakes can still occur in processing user voice inputs. To address such situations, the disclosure proposes a method and apparatus configured to manage these errors efficiently.

The disclosure provides an efficient method and system for processing voice inputs in a voice assistant device, enhancing overall performance. The proposed validation module validates the feasibility of executing the first candidate text output, thereby ensuring that the voice assistant device proceeds with further steps only when the feasibility of execution is determined as not feasible. Consequently, this process enhances the accuracy of the actions executed by the voice assistant device.

The disclosure also provides a failure identifier. When the feasibility of executing the first candidate text output is validated as not feasible, the proposed failure identifier determines the failure information. This ensures that errors are detected and corrected effectively.

The disclosure addresses the scenario where ASR (Automatic Speech Recognition) and NLP (Natural Language Processing) systems fail to detect errors propagated by initial mistakes in user voice input recognition. The disclosure uses techniques to convert speech into both textual and audio representations, identify and categorize failures in Natural Language Understanding (NLU), and correct errors in real-time. The voice assistant device's real-time failure detection and correction capabilities ensure more accurate and responsive voice assistance, reducing the propagation of errors.

The proposed intelligent hypothesis generation module activates when the execution validation fails and a failure in the overall result of the user voice input is recognized. This ensures that errors are detected and corrected effectively. Additionally, the intelligent hypothesis generation module generates a second list of candidate text outputs and corresponding text embeddings based on the failure information, the first list of candidate text outputs, and second contextual data related to the user and the voice assistant device. This ensures that the second candidate text output selected from the second list of candidate text outputs is the most accurate and appropriate response for the user's voice input.

The disclosure integrates input audio features (phonetic knowledge), contextual data related to the user and the voice assistant device, which includes a Knowledge Graph (KG), user data, and smart device data along with NLP sub-systems, which aids in performing user utterance correction effectively and thereby generating accurate and appropriate response for the user's voice input.

The disclosure dynamically corrects user inputs based on the overall confidence of the determined action. If low confidence is detected, the voice assistant device performs corrections to ensure accurate outcomes.

The pre-trained AI models enhances the adaptability and overall accuracy, leading to improved user interactions.

In light of the technical advancements provided by the disclosed method, the claimed steps, as discussed above, are not routine, conventional, or well-known aspects in the art, as the claimed steps provide the aforesaid solutions to the technical problems existing in the related art technologies. Further, the claimed steps clearly bring an improvement in the functioning of the system itself, as the claimed steps provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments. When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article, or a different number of devices/articles may be used instead of the shown number of devices or programs. The functionality and/or features of a device may be alternatively embodied by one or more other devices which are not explicitly described as having such functionality/features. Thus, other embodiments need not include the device itself.

Finally, the language used in the specification has been principally selected for readability and instructional purposes, and it may not have been selected to delineate or circumscribe the subject matter. It is therefore intended that the scope is not limited by this detailed description, but is defined by the claims. Accordingly, the embodiments are intended to be illustrative, but not limiting, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of processing voice input in a voice assistant device, the method comprising:
identifying a first candidate text output from a first list of candidate text outputs, the first list of candidate text outputs being generated based on a voice input being received from a user;
validating a feasibility of executing the first candidate text output based on an analysis of a first contextual data related to the first candidate text output, user-specific data, historical data related to previous validations of the voice assistant device, and one of an execution result or a no-action result corresponding to the first candidate text output;
based on the feasibility of executing the first candidate text output being validated as not feasible for execution, identifying failure information associated with the first candidate text output;
generating a second list of candidate text outputs and corresponding text embeddings based on the failure information, the first list of candidate text outputs, and second contextual data related to the user and the voice assistant device;
identifying a second candidate text output for the voice input from the second list of candidate text outputs based on a correlation of the corresponding text embeddings of each candidate text output of the second list of candidate text outputs with an audio embedding of the voice input; and
based on the voice input being received from the user, executing an action corresponding to the second candidate text output.

2. The method as claimed in claim 1, wherein the first candidate text output is identified based on the audio embedding of the voice input, text recognized from the voice input, and the first list of candidate text outputs generated for the voice input based on the audio embedding of the voice input and the text recognized from the voice input.

3. The method as claimed in claim 1, wherein validating the feasibility of executing comprises:
generating, through a first trained artificial intelligence (AI) model, the first contextual data related to the first candidate text output based on an analysis of the first candidate text output;
assigning, through the first trained AI model, a validation confidence score to the first candidate text output based on the analysis of the generated first contextual data, the user-specific data, and the historical data related to previous validations of the voice assistant device;
comparing, through the first trained AI model, the validation confidence score of the first candidate text output with a dynamic threshold value, wherein the dynamic threshold value is generated for the first candidate text output based on word level confidence score of each word of the first candidate text output and a contextual relationship between each word of the first candidate text output; and
validating, through the first trained AI model, the feasibility of executing the first candidate text output as feasible for execution or not feasible for execution.

4. The method as claimed in claim 1, wherein the feasibility of executing the first candidate text output is validated as feasible for execution based on the validation confidence score of the first candidate text output being greater than or equal to a dynamic threshold value; and
wherein the feasibility of executing the first candidate text output is validated as not feasible for execution based on the validation confidence score of the first candidate text output being less than the dynamic threshold value.

5. The method as claimed in claim 1, wherein the first contextual data comprises at least one of an intent of the first candidate text output, a slot of the first candidate text output, a word level confidence score of each word of the first candidate text output, contextual relationship between each word of the first candidate text output and a context associated with the voice input, and previous voice inputs of the user to the voice assistant device.

6. The method as claimed in claim 1, wherein the second contextual data comprises the user-specific data, data related to Internet of things (IoT) devices associated with the voice assistant device of the user, and a knowledge graph derived from centralized information related to previous validations performed by a plurality of voice assistant devices for a plurality of voice inputs, corresponding to executed actions and phonetically similar keywords.

7. The method as claimed in claim 1, wherein the failure information is identified by a trained AI classification model, and
wherein the failure information comprises at least one of a type of a failure associated with the first candidate text output, position of words responsible for the failure of the first candidate text output and a word level confidence score of each word responsible for the failure in the first candidate text output.

8. The method as claimed in claim 1 further comprising categorizing, by the voice assistant device, the failure information into a type of a failure,
wherein the type of the failure comprises at least one of a slot failure, an intent failure, a goal jump failure, or a planning failure.

9. The method as claimed in claim 1, wherein the second list of candidate text outputs and the corresponding text embeddings are generated by a second trained AI model, and
wherein the second list of candidate text outputs comprises a plurality of candidate text outputs phonetically similar to text recognized from the voice input.

10. The method as claimed in claim 1, wherein identifying the second candidate text output from the second list of candidate text outputs by a third trained AI model comprises:
identifying self-attention data based on text embeddings of each of a plurality of candidate text outputs in the second list of candidate text outputs;
identifying cross-attention data based on the text embeddings of each of the plurality of candidate text outputs in the second list of candidate text outputs and the audio embedding of the voice input;
assigning an attention score for each of the plurality of candidate text outputs in the second list of candidate text outputs based on the identified self-attention data and the identified cross-attention data; and
identifying the second candidate text output for the voice input from the plurality of candidate text outputs in the second list of candidate text outputs based on the attention score.

11. The method as claimed in claim 1, wherein the second candidate text output is executed based on the feasibility of execution of the second candidate text output being validated as feasible for execution.

12. The method as claimed in claim 1, further comprising identifying subsequent candidate text outputs consecutively based on the feasibility of executing the second candidate text output being validated as not feasible for execution, until one of:
the feasibility of executing one of the subsequent candidate text outputs is identified as feasible for execution; or
a number of validations of the subsequent candidate text outputs exceeds a predefined threshold number of validations.

13. A voice assistant device for processing voice input comprising:
at least one processor; and
memory storing instructions; and
at least one processor communicatively coupled to the memory and configured to execute the instructions,
wherein the instructions, when executed by the at least one processor, cause the voice assistant device to:
identify a first candidate text output from the first list of candidate text outputs, the first list of candidate text inputs being generated based on a voice input being received from a user;
validate a feasibility of executing the first candidate text output based on an analysis of a first contextual data related to the first candidate text output, user-specific data, historical data related to previous validations of the voice assistant device and one of an execution result or a no-action result corresponding to the first candidate text output;
based on the feasibility of executing the first candidate text output being validated as not feasible for execution, identify failure information associated with the first candidate text output;
generate a second list of candidate text outputs and corresponding text embeddings based on the failure information, the first list of candidate text outputs and second contextual data related to the user and the voice assistant device;
identify a second candidate text output for the voice input from the second list of candidate text outputs based on correlation of the corresponding text embeddings of each candidate text output of the second list of candidate text outputs with an audio embedding of the voice input; and
based on the voice input being received from the user, execute an action corresponding to the second candidate text output.

14. The voice assistant device as claimed in claim 13, wherein the instructions, when executed by the at least one processor, further cause the voice assistant device to identify the first candidate text output based on the audio embedding of the voice input, text recognized from the voice input and the first list of candidate text outputs generated for the voice input based on the audio embedding of the voice input and the text recognized from the voice input.

15. A non-transitory computer readable recording medium including a program that is executable by a processor to perform a controlling method of a voice assistant device, the controlling method comprising:
identifying a first candidate text output from the first list of candidate text outputs, the first list of candidate text outputs being generated based on a voice input being received from a user;
validating a feasibility of executing the first candidate text output based on analysis of a first contextual data related to the first candidate text output, user-specific data, historical data related to previous validations of the voice assistant device and one of an execution result or a no-action result corresponding to the first candidate text output;
based on the feasibility of executing the first candidate text output being validated as not feasible for execution, identifying failure information associated with the first candidate text output;
generating a second list of candidate text outputs and corresponding text embeddings based on the failure information, the first list of candidate text outputs and second contextual data related to the user and the voice assistant device;
identifying a second candidate text output for the voice input from the second list of candidate text outputs based on correlation of the corresponding text embeddings of each candidate text output of the second list of candidate text outputs with an audio embedding of the voice input; and
based on the voice input being received from the user, executing an action corresponding to the second candidate text output.

16. The non-transitory computer readable recording medium as claimed in claim 15, wherein the first candidate text output is identified based on the audio embedding of the voice input, text recognized from the voice input, and the first list of candidate text outputs generated for the voice input based on the audio embedding of the voice input and the text recognized from the voice input.

17. The non-transitory computer readable recording medium as claimed in claim 15, wherein the validating the feasibility of executing comprises:
generating, through a first trained artificial intelligence (AI) model, the first contextual data related to the first candidate text output based on an analysis of the first candidate text output;
assigning, through the first trained AI model, a validation confidence score to the first candidate text output based on the analysis of the generated first contextual data, the user-specific data, and the historical data related to previous validations of the voice assistant device;
comparing, through the first trained AI model, the validation confidence score of the first candidate text output with a dynamic threshold value, wherein the dynamic threshold value is generated for the first candidate text output based on word level confidence score of each word of the first candidate text output and a contextual relationship between each word of the first candidate text output; and
validating, through the first trained AI model, the feasibility of executing the first candidate text output as feasible for execution or not feasible for execution.

18. The non-transitory computer readable recording medium as claimed in claim 15, wherein the feasibility of executing the first candidate text output is validated as feasible for execution based on the validation confidence score of the first candidate text output being greater than or equal to a dynamic threshold value; and
wherein the feasibility of executing the first candidate text output is validated as not feasible for execution based on the validation confidence score of the first candidate text output being less than the dynamic threshold value.

19. The non-transitory computer readable recording medium as claimed in claim 15, wherein the first contextual data comprises at least one of an intent of the first candidate text output, a slot of the first candidate text output, a word level confidence score of each word of the first candidate text output, contextual relationship between each word of the first candidate text output and a context associated with the voice input, and previous voice inputs of the user to the voice assistant device.

20. The non-transitory computer readable recording medium as claimed in claim 15, wherein the second contextual data comprises the user-specific data, data related to Internet of things (IoT) devices associated with the voice assistant device of the user, and a knowledge graph derived from centralized information related to previous validations performed by a plurality of voice assistant devices for a plurality of voice inputs, corresponding to executed actions and phonetically similar keywords.
